(19) United States
(12) Patent Application Publication
(10) Pub. No.: US 2026/0244017 A1
(43) Pub. Date: Aug. 20, 2026

(54) DIFFRACTIVE STRUCTURES FOR ASYMMETRIC LIGHT EXTRACTION AND AUGMENTED REALITY DEVICES INCLUDING THE SAME

(71) Applicant: Magic Leap, Inc., Plantation, FL (US)

(72) Inventors: Ravi Kumar KOMANDURI, Austin, TX (US); Vikramjit SINGH, Pflugerville, TX (US); Shuqiang YANG, Austin, TX (US); Chinmay KHANDEKAR, Sunnyvale, CA (US); Frank Y. XU, Austin, TX (US); Robert Dale TEKOLSTE, Boulder, CO (US); Kang LUO, Austin, TX (US); Chulwoo OH, Sammamish, WA (US); Victor Kai LIU, West Point, CA (US)

(21) Appl. No.: 18/871,378

(22) PCT Filed: Jun. 3, 2022
(86) PCT No.: PCT/US2022/032256

§ 371 Date: Dec. 3, 2024

(51) Int. Cl. G02B 27/01

(52) U.S. Cl. CPC G02B 27/0172

(57) ABSTRACT

A head-mounted display system includes a head-mountable frame; a light projection system configured to output light to provide image content; a waveguide supported by the frame, the waveguide configured to guide at least a portion of the light from the light projection system coupled into the waveguide; a diffractive structure optically coupled to the waveguide, the diffractive structure being configured to couple light guided by the waveguide out of the waveguide towards a user side of the head-mounted display, the diffractive structure having a grating layer with multiple ridges each having a side face that is slanted or stepped with respect to a plane of the waveguide. The diffractive structure directs at least 25% more light guided by the waveguide towards the user side than the world side.

### BACKGROUND

### Field

The present disclosure relates to display systems and, more particularly, to augmented and virtual reality display systems and diffractive structures for use therewith.

### Description of the Related Art

Modem computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR”, scenario typically involves presentation of digital or virtual image information without transparency to other actual real-world visual input; an augmented reality, or “AR”, scenario typically involves presentation of digital or virtual image information as an augmentation to visualization of the actual world around the user. A mixed reality, or “MR”, scenario is a type of AR scenario and typically involves virtual objects that are integrated into, and responsive to, the natural world. For example, in an MR scenario, AR image content may be blocked by or otherwise be perceived as interacting with objects in the real world.

Referring to FIG. 1, an augmented reality scene 10 is depicted wherein a user of an AR technology sees a real-world park-like setting 20 featuring people, trees, buildings in the background, and a concrete platform 30. In addition to these items, the user of the AR technology also perceives that he “sees” “virtual content” such as a robot statue 40 standing upon the real-world platform 30, and a cartoon-like avatar character 50 flying by which seems to be a personification of a bumble bee, even though these elements 40, 50 do not exist in the real world. Because the human visual perception system is complex, it is challenging to produce an AR technology that facilitates a comfortable, natural-feeling, rich presentation of virtual image elements amongst other virtual or real-world imagery elements.

Systems and methods disclosed herein address various challenges related to AR and VR technology.

### SUMMARY

Diffractive structures for an Exit Pupil Expander (EPE) and/or Combined Pupil Expander (CPE) are described that can improve the optical efficiency of a waveguide based augmented reality (AR) device by directing more light from the waveguide to the user side rather than the world side of the device. Surface relief diffractive structures are described that can be implemented on one or both sides of an eyepiece.

Various aspects of the disclosed subject matter are summarized as follows.

In general, in a first aspect, the disclosure features a head-mounted display system including: a head-mountable frame; a light projection system configured to output light to provide image content; a waveguide supported by the frame, the waveguide configured to guide at least a portion of the light from the light projection system coupled into the waveguide; a diffractive structure optically coupled to the waveguide, the diffractive structure being configured to couple light guided by the waveguide out of the waveguide towards a user side of the head-mounted display, the diffractive structure having a grating layer with multiple ridges (e.g., grating lines) each having a side face that is slanted or stepped with respect to a plane of the waveguide. The diffractive structure directs at least 25% more light guided by the waveguide towards the user side than the world side.

Examples of the head-mounted display system can include one or more of the following features. For example, the ridges can have a profile shape selected: trapezoidal (e.g., slanted gratings, such as sharkfin gratings, truncated triangular gratings), parallelogram (e.g., slanted gratings), triangular (e.g., sawtooth and other blazed grating shapes), and stepped (e.g., where each step has the same shape, or steps with different shapes).

The side face can subtend an angle in a range from 20° to 80° (e.g., about 300 or more, about 400 or more, about 500 or more, about 60° or more, about 80° or less, about 700 or less) with respect to the plane of the waveguide. The ridges can have a height in a range from 10 nm to 1,000 nm (e.g., 50 nm to 500 nm, 100 nm to 400 nm, 200 nm to 400 nm, 250 nm to 350 nm). The ridges can have a pitch in a range from 100 nm to 5,000 nm (e.g., 100 nm to 2,500 nm, 100 nm to 1,000 nm, 200 nm to 750 nm, 250 nm to 500 nm, 300 nm to 400 nm, 100 nm to 200 nm). The ridges have a duty cycle in a range from 20% to 100% (e.g., 10% to 75%, 20% to 50%, 30% to 40%).

The head-mounted display can include a layer of material having a refractive index the same as a material forming the ridges of the diffractive structure, the layer of material being arranged between the waveguide and the diffractive structure. The layer can have a thickness in a range from 5 nm to 50 nm (e.g., 10 nm to 30 nm, 10 nm to 20 nm). The grating layer can include a grating material having a refractive index of 1.5 or more (e.g., 1.6 or more, 1.7 or more, 1.8 or more, 1.9 or more) at the operative wavelength.

The head-mounted display can include an input coupling grating (ICG) arranged to couple light into the waveguide, wherein the ICG and the diffractive structure are arranged on a same side of the waveguide.

In some examples, the head-mounted display can include an input coupling grating (ICG) arranged to couple light into the waveguide, wherein the ICG and the diffractive structure are arranged on opposite sides of the waveguide.

The diffractive structure can be a component of an Exit Pupil Expander (EPE) or a combined pupil expander (CPE) of the head-mounted display. The diffractive structure can be a first diffractive structure and the EPE or CPE further includes a second diffractive structure on an opposite side of the waveguide from the first diffractive structure.

The diffractive structure can include multiple zones, wherein a structure of the grating layer in at least two of the zones is different. The grating structure of the grating layer can change abruptly from a first zone to a second zone neighboring the first zone. In some examples, the grating structure of the grating layer changes continuously across an area of the diffractive structure.

At least some of the ridges can have a single-step geometry.

Alternatively, or additionally, at least some of the ridges have a multi-step geometry. The ridges with a multi-step geometry can include steps with a sloped geometry.

The diffractive structure can direct at least 100% more light guided by the waveguide towards the user side than the world side.

The diffractive structure can direct at least 4% of light (e.g., 5% or more, 6% or more, 7% or more, 8% or more, 9% or more, 10% or more, 11% or more, 12% or more, 13% or more, 14% or more, 15% or more, such as up to 20%) from the waveguide to the user side.

The grating layer can be etched into the waveguide. Alternatively, the grating layer can be formed in a layer of material deposited on the waveguide (e.g., the layer of material having a refractive index in a range from 1.5 to 2.7).

The diffractive structure can include a layer of material deposited on the ridges of the grating layer. The layer of material can be deposited on fewer than all of the faces of the ridges. The layer of material can be deposited on all of the faces of the ridge. The layer of material can have a refractive index in a range from 1.7 to 2.7. The layer of material can have a refractive index in a range from 1.3 to 1.5.

Other features and advantages will be apparent from the drawings, the description below, and the claims.

### BRIEF DESCRIPTION OF THE DRAWINGS

FIG. 1 illustrates a user's view of augmented reality (AR) through an AR device.

FIG. 2 illustrates a conventional display system for simulating three-dimensional imagery for a user.

FIGS. 3A-3C illustrate relationships between radius of curvature and focal radius.

FIG. 4A illustrates a representation of the accommodation-vergence response of the human visual system.

FIG. 4B illustrates examples of different accommodative states and vergence states of a pair of eyes of the user.

FIG. 4C illustrates an example of a representation of a top-down view of a user viewing content via a display system.

FIG. 4D illustrates another example of a representation of a top-down view of a user viewing content via a display system.

FIG. 5 illustrates aspects of an approach for simulating three-dimensional imagery by modifying wavefront divergence.

FIG. 6 illustrates an example of a waveguide stack for outputting image information to a user.

FIG. 7 illustrates an example of exit beams outputted by a waveguide.

FIG. 8 illustrates an example of a stacked waveguide assembly in which each depth plane includes images formed using multiple different component colors.

FIG. 9A illustrates a cross-sectional side view of an example of a set of stacked waveguides that each includes an incoupling optical element.

FIG. 9B illustrates a perspective view of an example of the plurality of stacked waveguides of FIG. 9A.

FIG. 9C illustrates a top-down plan view of an example of the plurality of stacked waveguides of FIGS. 9A and 9B.

FIG. 9D illustrates an example of wearable display system.

FIG. 10 schematically illustrates a cross-sectional view of a portion of a waveguide having disposed thereon a diffraction grating, for example, for in-coupling light into the waveguide.

FIG. 11A is a cross-sectional view of an example diffractive structure composed of a slanted grating.

FIG. 11B is a schematic diagram showing light propagation direction for simulations performed for an EPE having the diffractive structure shown in FIG. 11A.

FIG. 12A-12D are intensity plots showing different performance parameters swept over slant angle and grating thickness for the slanted grating shown in FIG. 11A. These plots were generated by simulation.

FIG. 13A-13D show cross-sectional profiles for four different slanted grating designs that were investigated by simulation.

FIG. 14A is a cross-sectional view of another example diffractive structure composed of a blazed grating.

FIGS. 14B-14D show cross-sectional profiles for three different blazed grating designs that were investigated by simulation.

FIGS. 15A and 15B are schematic diagrams showing example single side arrangements for an eyepiece.

FIGS. 15C and 15D are schematic diagrams showing example double side arrangements for an eyepiece.

FIG. 16A is a schematic diagram showing an example layout of a diffractive structure for an EPE and/or CPE with different zones having different grating structures.

FIGS. 16B-16D are cross-sectional views showing the grating structures for the different zones of the diffractive structure shown in FIG. 16A.

FIGS. 17A-17B are cross-sectional views showing example diffractive structures for a CPE.

FIG. 18A is a plot showing grating thickness for different zones for the example diffractive structures shown in FIGS. 17A-17B.

FIGS. 18B and 18C are plan views showing the zone layout for the example diffractive structures shown in FIGS. 17A-17B.

FIG. 19A shows cross-sectional views of portions of a grating structure in which a grating pattern is transferred from a resist layer to a substrate layer by dry etching.

FIG. 19B is an SEM micrograph of an example grating structure formed in the manner depicted in FIG. 19A.

FIGS. 20A-20K are SEM micrographs of different examples of surface relief diffractive structures suitable for EPEs and/or CPEs.

FIG. 21A-21D shows example eyepieces in cross-section that include double-sided gratings.

FIG. 21E show examples of grating structures in cross section that include various combinations of coatings on the grating ridges.

FIGS. 22A-22D shows example cross-sectional shapes of grating ridges including stepped ridges.

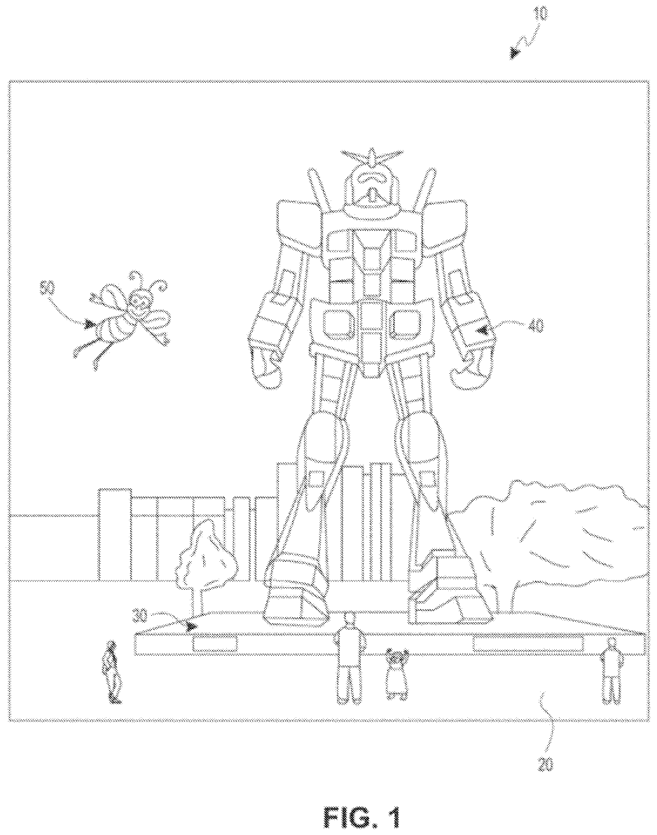

Throughout the drawings, reference numbers may be re-used to indicate correspondence between referenced elements. The drawings are provided to illustrate example embodiments described herein and are not intended to limit the scope of the disclosure.

### DETAILED DESCRIPTION

AR systems may display virtual content to a user, or viewer, while still allowing the user to see the world around them. Preferably, this content is displayed on a head-mounted display, e.g., as part of eyewear, that projects image information to the user's eyes. In addition, the display may also transmit light from the surrounding environment to the user's eyes, to allow a view of that surrounding environment. As used herein, it will be appreciated that a “head-mounted” or “head mountable” display is a display that may be mounted on the head of a viewer or user.

In some AR systems, virtual/augmented/mixed display having a relatively high field of view (FOV) can enhance the viewing experience. The FOV of the display depends on the angle of light output by waveguides of the eyepiece, through which the viewer sees images projected into his or her eye. A waveguide having a relatively high refractive index, e.g., 2.0 or greater, can provide a relatively high FOV. However, to efficiently couple light into the high refractive index waveguide, the diffractive optical coupling elements should also have a correspondingly high refractive index. To achieve this goal, among other advantages, some displays for AR systems according to embodiments described herein include a waveguide having a relatively high index (e.g., greater than or equal to 2.0) material, having formed thereon respective diffraction gratings with correspondingly high refractive index, such a Li-based oxide. For example, a diffraction grating may be formed directly on a Li-based oxide waveguide by patterning a surface portion of the waveguide formed of a Li-based oxide.

Some high refractive index diffractive optical coupling elements such as in-coupling or out-coupling optical elements have strong polarization dependence. For example, in-coupling gratings (ICGs) for in-coupling light into a waveguide wherein the diffractive optical coupling element comprises high refractive index material may admit light of a given polarization significantly more than light of another polarization. Such elements may, for example, in-couple light with TM polarization into the waveguide at a rate approximately 3 times that of light with TE polarization. Diffractive optical coupling elements with this kind of polarization dependence may have reduced efficiency (due to the poor efficiency and general rejection of one polarization) and may also create coherent artifacts and reduce the uniformity of a far field image formed by light coupled out of the waveguide. To obtain diffractive optical coupling elements that are polarization-insensitive or at least that have reduced polarization sensitivity (e.g., that couple light with an efficiency that is relatively independent of polarization), some displays for AR systems according to various implementations described herein include a waveguide with diffraction gratings formed with blazed geometries. The diffraction grating may also be formed directly in the waveguide, which may comprise high index material (e.g., having an index of refraction of at least 1.9, 2.0, 2.1, 2.2, 2.3, 2.4, 2.5, 2.6, or up to 2.7 or a value in any range between any of these values). A diffractive grating may, for example, be formed in high index materials such as such as Li-based oxide like lithium niobate (LiNbO₃) or lithium tantalate (LiTaO₃) or such as zirconium oxide (ZrO₂), titanium dioxide (TiO₂) or silicon carbide (SiC), for example, by patterning the high index material with a blazed geometry.

Reference will now be made to the drawings, in which like reference numerals refer to like parts throughout. Unless indicated otherwise, the drawings are schematic not necessarily drawn to scale.

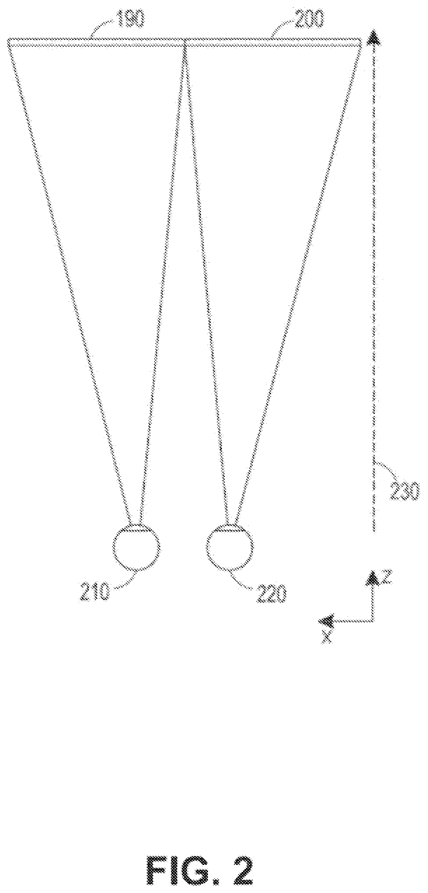

FIG. 2 illustrates a conventional display system for simulating three-dimensional imagery for a user. A user's eyes are spaced apart and that, when looking at a real object in space, each eye will have a slightly different view of the object and may form an image of the object at different locations on the retina of each eye. This may be referred to as binocular disparity and may be utilized by the human visual system to provide a perception of depth. Conventional display systems simulate binocular disparity by presenting two distinct images 190, 200 with slightly different views of the same virtual object—one for each eye 210, 220—corresponding to the views of the virtual object that would be seen by each eye were the virtual object a real object at a desired depth. These images provide binocular cues that the user's visual system may interpret to derive a perception of depth.

With continued reference to FIG. 2, the images 190, 200 are spaced from the eyes 210, 220 by a distance 230 on a z-axis. The z-axis is parallel to the optical axis of the viewer with their eyes fixated on an object at optical infinity directly ahead of the viewer. The images 190, 200 are flat and at a fixed distance from the eyes 210, 220. Based on the slightly different views of a virtual object in the images presented to the eyes 210, 220, respectively, the eyes may naturally rotate such that an image of the object falls on corresponding points on the retinas of each of the eyes, to maintain single binocular vision. This rotation may cause the lines of sight of each of the eyes 210, 220 to converge onto a point in space at which the virtual object is perceived to be present. As a result, providing three-dimensional imagery conventionally involves providing binocular cues that may manipulate the vergence of the user's eyes 210, 220, and that the human visual system interprets to provide a perception of depth.

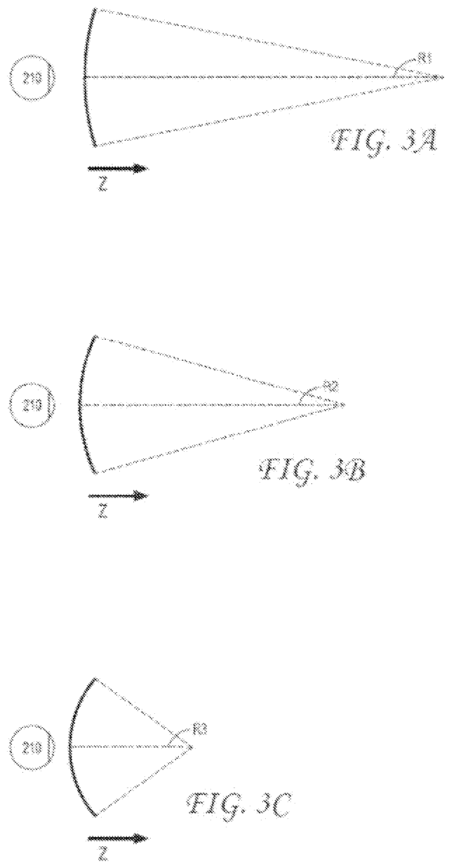

Generating a realistic and comfortable perception of depth is challenging, however. It will be appreciated that light from objects at different distances from the eyes have wavefronts with different amounts of divergence. FIGS. 3A-3C illustrate relationships between distance and the divergence of light rays. The distance between the object and the eye 210 is represented by, in order of decreasing distance, R1, R2, and R3. As shown in FIGS. 3A-3C, the light rays become more divergent as distance to the object decreases. Conversely, as distance increases, the light rays become more collimated. Stated another way, it may be said that the light field produced by a point (the object or a part of the object) has a spherical wavefront curvature, which is a function of how far away the point is from the eye of the user. The curvature increases with decreasing distance between the object and the eye 210. While only a single eye 210 is illustrated for clarity of illustration in FIGS. 3A-3C and other figures herein, the discussions regarding eye 210 may be applied to both eyes 210 and 220 of a viewer.

With continued reference to FIGS. 3A-3C, light from an object that the viewer's eyes are fixated on may have different degrees of wavefront divergence. Due to the different amounts of wavefront divergence, the light may be focused differently by the lens of the eye, which in turn may require the lens to assume different shapes to form a focused image on the retina of the eye. Where a focused image is not formed on the retina, the resulting retinal blur acts as a cue to accommodation that causes a change in the shape of the lens of the eye until a focused image is formed on the retina. For example, the cue to accommodation may trigger the ciliary muscles surrounding the lens of the eye to relax or contract, thereby modulating the force applied to the suspensory ligaments holding the lens, thus causing the shape of the lens of the eye to change until retinal blur of an object of fixation is eliminated or minimized, thereby forming a focused image of the object of fixation on the retina (e.g., fovea) of the eye. The process by which the lens of the eye changes shape may be referred to as accommodation, and the shape of the lens of the eye required to form a focused image of the object of fixation on the retina (e.g., fovea) of the eye may be referred to as an accommodative state.

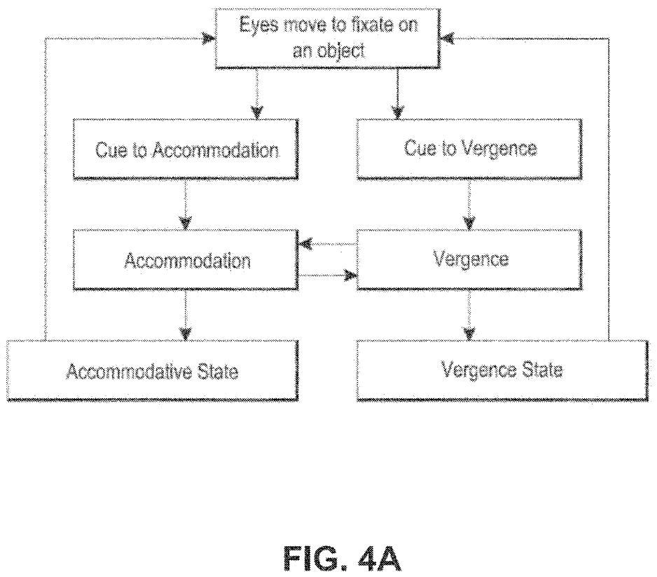

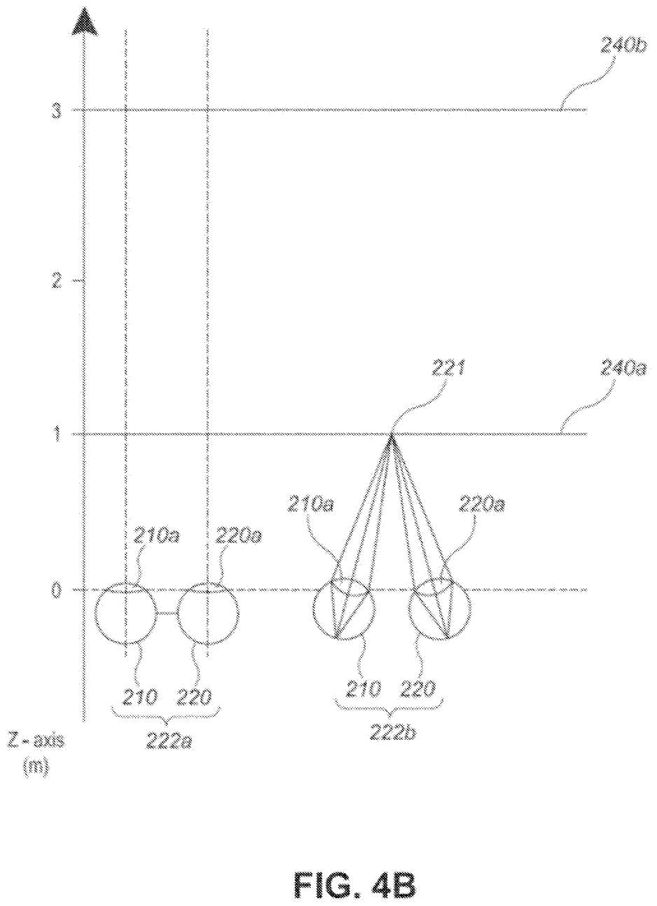

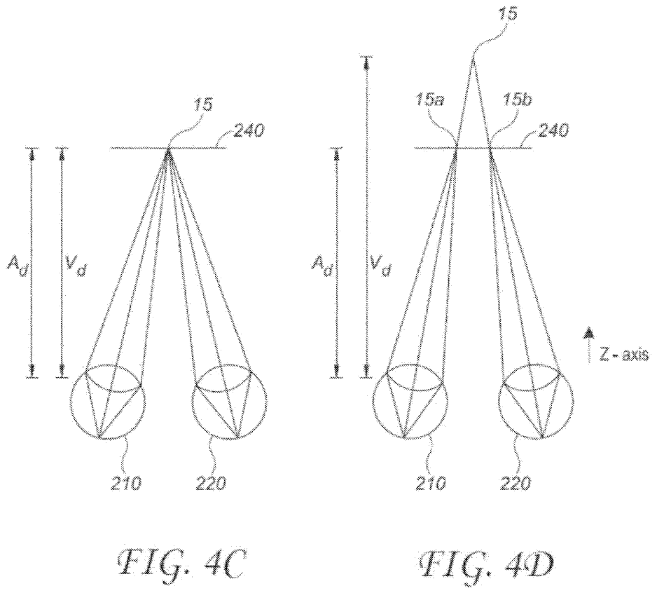

With reference now to FIG. 4A, a representation of the accommodation-vergence response of the human visual system is illustrated. The movement of the eyes to fixate on an object causes the eyes to receive light from the object, with the light forming an image on each of the retinas of the eyes. The presence of retinal blur in the image formed on the retina may provide a cue to accommodation, and the relative locations of the image on the retinas may provide a cue to vergence. The cue to accommodation causes accommodation to occur, resulting in the lenses of the eyes each assuming a particular accommodative state that forms a focused image of the object on the retina (e.g., fovea) of the eye. On the other hand, the cue to vergence causes vergence movements (rotation of the eyes) to occur such that the images formed on each retina of each eye are at corresponding retinal points that maintain single binocular vision. In these positions, the eyes may be said to have assumed a particular vergence state. With continued reference to FIG. 4A, accommodation may be understood to be the process by which the eye achieves a particular accommodative state, and vergence may be understood to be the process by which the eye achieves a particular vergence state. As indicated in FIG. 4A, the accommodative and vergence states of the eyes may change if the user fixates on another object. For example, the accommodated state may change if the user fixates on a new object at a different depth on the z-axis.

Without being limited by theory, it is believed that viewers of an object may perceive the object as being “three-dimensional” due to a combination of vergence and accommodation. As noted above, vergence movements (e.g., rotation of the eyes so that the pupils move toward or away from each other to converge the lines of sight of the eyes to fixate upon an object) of the two eyes relative to each other are closely associated with accommodation of the lenses of the eyes. Under normal conditions, changing the shapes of the lenses of the eyes to change focus from one object to another object at a different distance will automatically cause a matching change in vergence to the same distance, under a relationship known as the “accommodation-vergence reflex.” Likewise, a change in vergence will trigger a matching change in lens shape under normal conditions.

With reference now to FIG. 4B, examples of different accommodative and vergence states of the eyes are illustrated. The pair of eyes 222a is fixated on an object at optical infinity, while the pair eyes 222b are fixated on an object 221 at less than optical infinity. Notably, the vergence states of each pair of eyes is different, with the pair of eyes 222a directed straight ahead, while the pair of eyes 222 converge on the object 221. The accommodative states of the eyes forming each pair of eyes 222a and 222b are also different, as represented by the different shapes of the lenses 210a, 220a.

Undesirably, many users of conventional “3-D” display systems find such conventional systems to be uncomfortable or may not perceive a sense of depth at all due to a mismatch between accommodative and vergence states in these displays. As noted above, many stereoscopic or “3-D” display systems display a scene by providing slightly different images to each eye. Such systems are uncomfortable for many viewers, since they, among other things, simply provide different presentations of a scene and cause changes in the vergence states of the eyes, but without a corresponding change in the accommodative states of those eyes. Rather, the images are shown by a display at a fixed distance from the eyes, such that the eyes view all the image information at a single accommodative state. Such an arrangement works against the “accommodation-vergence reflex” by causing changes in the vergence state without a matching change in the accommodative state. This mismatch is believed to cause viewer discomfort. Display systems that provide a better match between accommodation and vergence may form more realistic and comfortable simulations of three-dimensional imagery.

Without being limited by theory, it is believed that the human eye typically may interpret a finite number of depth planes to provide depth perception. Consequently, a highly believable simulation of perceived depth may be achieved by providing, to the eye, different presentations of an image corresponding to each of these limited numbers of depth planes. In some embodiments, the different presentations may provide both cues to vergence and matching cues to accommodation, thereby providing physiologically correct accommodation-vergence matching.

With continued reference to FIG. 4B, two depth planes 240, corresponding to different distances in space from the eyes 210, 220, are illustrated. For a given depth plane 240, vergence cues may be provided by the displaying of images of appropriately different perspectives for each eye 210, 220. In addition, for a given depth plane 240, light forming the images provided to each eye 210, 220 may have a wavefront divergence corresponding to a light field produced by a point at the distance of that depth plane 240.

In the illustrated embodiment, the distance, along the z-axis, of the depth plane 240 containing the point 221 is 1 m. As used herein, distances or depths along the z-axis may be measured with a zero-point located at the exit pupils of the user's eyes. Thus, a depth plane 240 located at a depth of 1 m corresponds to a distance of 1 m away from the exit pupils of the user's eyes, on the optical axis of those eyes with the eyes directed towards optical infinity. As an approximation, the depth or distance along the z-axis may be measured from the display in front of the user's eyes (e.g., from the surface of a waveguide), plus a value for the distance between the device and the exit pupils of the user's eyes. That value may be called the eye relief and corresponds to the distance between the exit pupil of the user's eye and the display worn by the user in front of the eye. In practice, the value for the eye relief may be a normalized value used generally for all viewers. For example, the eye relief may be assumed to be 20 mm and a depth plane that is at a depth of 1 m may be at a distance of 980 mm in front of the display.

With reference now to FIGS. 4C and 4D, examples of matched accommodation-vergence distances and mismatched accommodation-vergence distances are illustrated, respectively. As illustrated in FIG. 4C, the display system may provide images of a virtual object to each eye 210, 220. The images may cause the eyes 210, 220 to assume a vergence state in which the eyes converge on a point 15 on a depth plane 240. In addition, the images may be formed by a light having a wavefront curvature corresponding to real objects at that depth plane 240. As a result, the eyes 210, 220 assume an accommodative state in which the images are in focus on the retinas of those eyes. Thus, the user may perceive the virtual object as being at the point 15 on the depth plane 240.

It will be appreciated that each of the accommodative and vergence states of the eyes 210, 220 are associated with a particular distance on the z-axis. For example, an object at a particular distance from the eyes 210, 220 causes those eyes to assume particular accommodative states based upon the distances of the object. The distance associated with a particular accommodative state may be referred to as the accommodation distance, Ad. Similarly, there are particular vergence distances, Vd, associated with the eyes in particular vergence states, or positions relative to one another. Where the accommodation distance and the vergence distance match, the relationship between accommodation and vergence may be said to be physiologically correct. This is considered to be the most comfortable scenario for a viewer.

In stereoscopic displays, however, the accommodation distance and the vergence distance may not always match. For example, as illustrated in FIG. 4D, images displayed to the eyes 210, 220 may be displayed with wavefront divergence corresponding to depth plane 240, and the eyes 210, 220 may assume a particular accommodative state in which the points 15a, 15b on that depth plane are in focus. However, the images displayed to the eyes 210, 220 may provide cues for vergence that cause the eyes 210, 220 to converge on a point 15 that is not located on the depth plane 240. As a result, the accommodation distance corresponds to the distance from the exit pupils of the eyes 210, 220 to the depth plane 240, while the vergence distance corresponds to the larger distance from the exit pupils of the eyes 210, 220 to the point 15, in some embodiments. The accommodation distance is different from the vergence distance. Consequently, there is an accommodation-vergence mismatch. Such a mismatch is considered undesirable and may cause discomfort in the user. It will be appreciated that the mismatch corresponds to distance (e.g., Vd-Ad) and may be characterized using diopters.

In some embodiments, it will be appreciated that a reference point other than exit pupils of the eyes 210, 220 may be utilized for determining distance for determining accommodation-vergence mismatch, so long as the same reference point is utilized for the accommodation distance and the vergence distance. For example, the distances could be measured from the cornea to the depth plane, from the retina to the depth plane, from the eyepiece (e.g., a waveguide of the display device) to the depth plane, and so on.

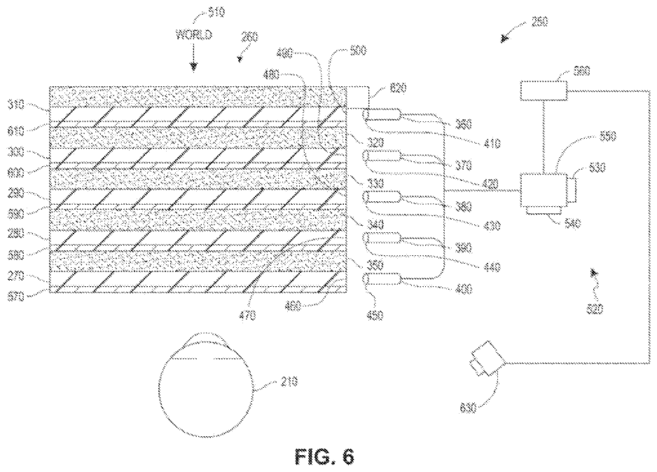

Without being limited by theory, it is believed that users may still perceive accommodation-vergence mismatches of up to about 0.25 diopter, up to about 0.33 diopter, and up to about 0.5 diopter as being physiologically correct, without the mismatch itself causing significant discomfort. In some embodiments, display systems disclosed herein (e.g., the display system 250, FIG. 6) present images to the viewer having accommodation-vergence mismatch of about 0.5 diopter or less. In some other embodiments, the accommodation-vergence mismatch of the images provided by the display system is about 0.33 diopter or less. In yet other embodiments, the accommodation-vergence mismatch of the images provided by the display system is about 0.25 diopter or less, including about 0.1 diopter or less.

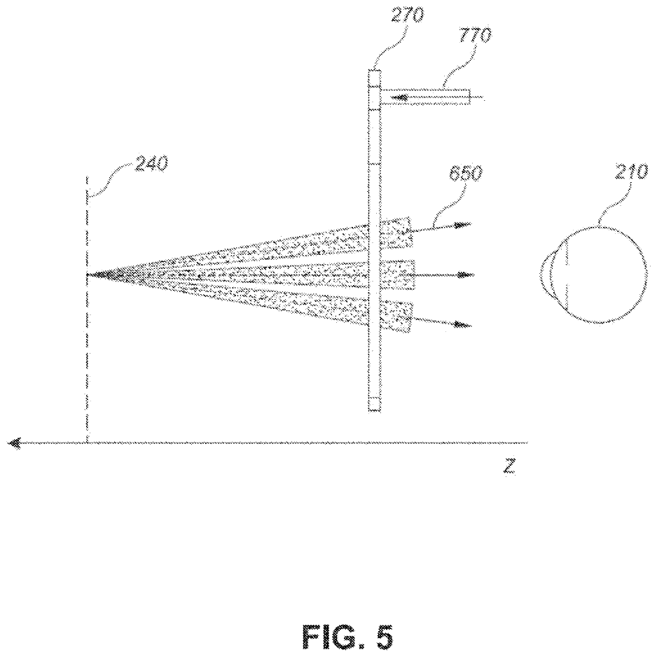

FIG. 5 illustrates aspects of an approach for simulating three-dimensional imagery by modifying wavefront divergence. The display system includes a waveguide 270 that is configured to receive light 770 that is encoded with image information, and to output that light to the user's eye 210. The waveguide 270 may output the light 650 with a defined amount of wavefront divergence corresponding to the wavefront divergence of a light field produced by a point on a desired depth plane 240. In some embodiments, the same amount of wavefront divergence is provided for all objects presented on that depth plane. In addition, it will be illustrated that the other eye of the user may be provided with image information from a similar waveguide.

In some embodiments, a single waveguide may be configured to output light with a set amount of wavefront divergence corresponding to a single or limited number of depth planes and/or the waveguide may be configured to output light of a limited range of wavelengths. Consequently, in some embodiments, a plurality or stack of waveguides may be utilized to provide different amounts of wavefront divergence for different depth planes and/or to output light of different ranges of wavelengths. As used herein, it will be appreciated at a depth plane may be planar or may follow the contours of a curved surface.

FIG. 6 illustrates an example of a waveguide stack for outputting image information to a user. A display system 250 includes a stack of waveguides, or stacked waveguide assembly, 260 that may be utilized to provide three-dimensional perception to the eye/brain using a plurality of waveguides 270, 280, 290, 300, 310. It will be appreciated that the display system 250 may be considered a light field display in some embodiments. In addition, the waveguide assembly 260 may also be referred to as an eyepiece.

In some embodiments, the display system 250 is configured to provide substantially continuous cues to vergence and multiple discrete cues to accommodation. The cues to vergence can be provided by displaying different images to each of the eyes of the user, and the cues to accommodation may be provided by outputting the light that forms the images with selectable discrete amounts of wavefront divergence. Stated another way, the display system 250 may be configured to output light with variable levels of wavefront divergence. In some embodiments, each discrete level of wavefront divergence corresponds to a particular depth plane and may be provided by a particular one of the waveguides 270, 280, 290, 300, 310.

With continued reference to FIG. 6, the waveguide assembly 260 may also include a plurality of features 320, 330, 340, 350 between the waveguides. In some embodiments, the features 320, 330, 340, 350 may be one or more lenses. The waveguides 270, 280, 290, 300, 310 and/or the plurality of lenses 320, 330, 340, 350 may be configured to send image information to the eye with various levels of wavefront curvature or light ray divergence. Each waveguide level may be associated with a particular depth plane and can be configured to output image information corresponding to that depth plane. Image injection devices 360, 370, 380, 390, 400 may function as a source of light for the waveguides and may be utilized to inject image information into the waveguides 270, 280, 290, 300, 310, each of which may be configured, as described herein, to distribute incoming light across each respective waveguide, for output toward the eye 210. Light exits an output surface 410, 420, 430, 440, 450 of the image injection devices 360, 370, 380, 390, 400 and is injected into a corresponding input surface 460, 470, 480, 490, 500 of the waveguides 270, 280, 290, 300, 310. In some embodiments, each of the input surfaces 460, 470, 480, 490, 500 may be an edge of a corresponding waveguide, or may be part of a major surface of the corresponding waveguide (that is, one of the waveguide surfaces directly facing the world 510 or the viewer's eye 210). In some embodiments, a single beam of light (e.g. a collimated beam) may be injected into each waveguide to output an entire field of cloned collimated beams that are directed toward the eye 210 at particular angles (and amounts of divergence) corresponding to the depth plane associated with a particular waveguide. In some embodiments, a single one of the image injection devices 360, 370, 380, 390, 400 may be associated with and inject light into a plurality (e.g., three) of the waveguides 270, 280, 290, 300, 310.

In some embodiments, the image injection devices 360, 370, 380, 390, 400 are discrete displays that each produce image information for injection into a corresponding waveguide 270, 280, 290, 300, 310, respectively. In some other embodiments, the image injection devices 360, 370, 380, 390, 400 are the output ends of a single multiplexed display which may, e.g., pipe image information via one or more optical conduits (such as fiber optic cables) to each of the image injection devices 360, 370, 380, 390, 400. It will be appreciated that the image information provided by the image injection devices 360, 370, 380, 390, 400 may include light of different wavelengths, or colors (e.g., different component colors, as discussed herein).

In some embodiments, the light injected into the waveguides 270, 280, 290, 300, 310 is provided by a light projector system 520, which comprises a light module 530, which may include a light emitter, such as a light emitting diode (LED). The light from the light module 530 may be directed to and modified by a light modulator 540, e.g., a spatial light modulator, via a beam splitter 550. The light modulator 540 may be configured to change the perceived intensity of the light injected into the waveguides 270, 280, 290, 300, 310 to encode the light with image information. Examples of spatial light modulators include liquid crystal displays (LCD) including a liquid crystal on silicon (LCOS) displays. It will be appreciated that the image injection devices 360, 370, 380, 390, 400 are illustrated schematically and, in some embodiments, these image injection devices may represent different light paths and locations in a common projection system configured to output light into associated ones of the waveguides 270, 280, 290, 300, 310. In some embodiments, the waveguides of the waveguide assembly 260 may function as ideal lens while relaying light injected into the waveguides out to the user's eyes. In this conception, the object may be the spatial light modulator 540 and the image may be the image on the depth plane.

In some examples, LED displays can be used in light projector system 520. LED displays can unpolarized light over a large range of angles. Accordingly, LED displays can beneficially provide imagery over wide fields of view with high efficiency.

In some embodiments, the display system 250 may be a scanning fiber display with one or more scanning fibers configured to project light in various patterns (e.g., raster scan, spiral scan, Lissajous patterns, etc.) into one or more waveguides 270, 280, 290, 300, 310 and ultimately to the eye 210 of the viewer. In some embodiments, the illustrated image injection devices 360, 370, 380, 390, 400 may schematically represent a single scanning fiber or a bundle of scanning fibers configured to inject light into one or a plurality of the waveguides 270, 280, 290, 300, 310. In some other embodiments, the illustrated image injection devices 360, 370, 380, 390, 400 may schematically represent a plurality of scanning fibers or a plurality of bundles of scanning fibers, each of which are configured to inject light into an associated one of the waveguides 270, 280, 290, 300, 310. It will be appreciated that one or more optical fibers may be configured to transmit light from the light module 530 to the one or more waveguides 270, 280, 290, 300, 310. It will be appreciated that one or more intervening optical structures may be provided between the scanning fiber, or fibers, and the one or more waveguides 270, 280, 290, 300, 310 to, e.g., redirect light exiting the scanning fiber into the one or more waveguides 270, 280, 290, 300, 310.

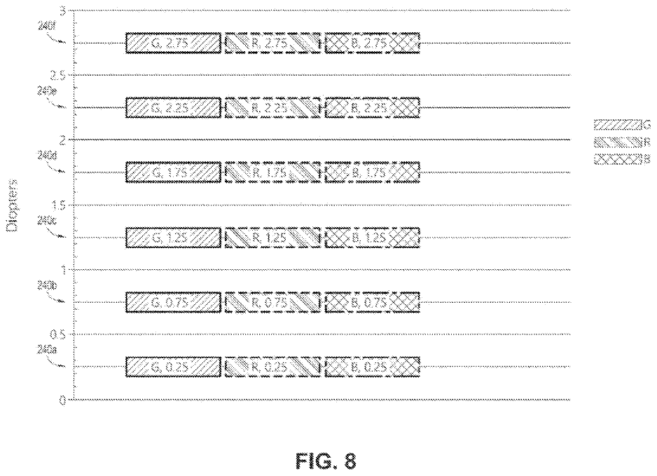

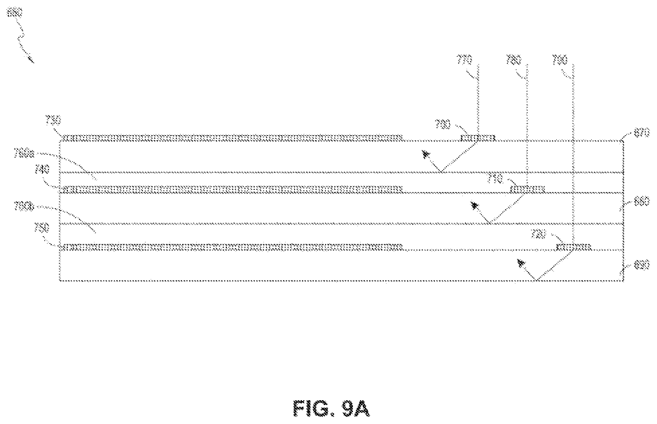

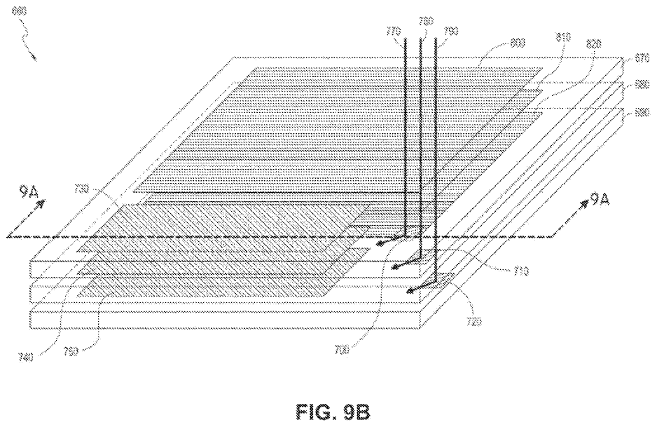

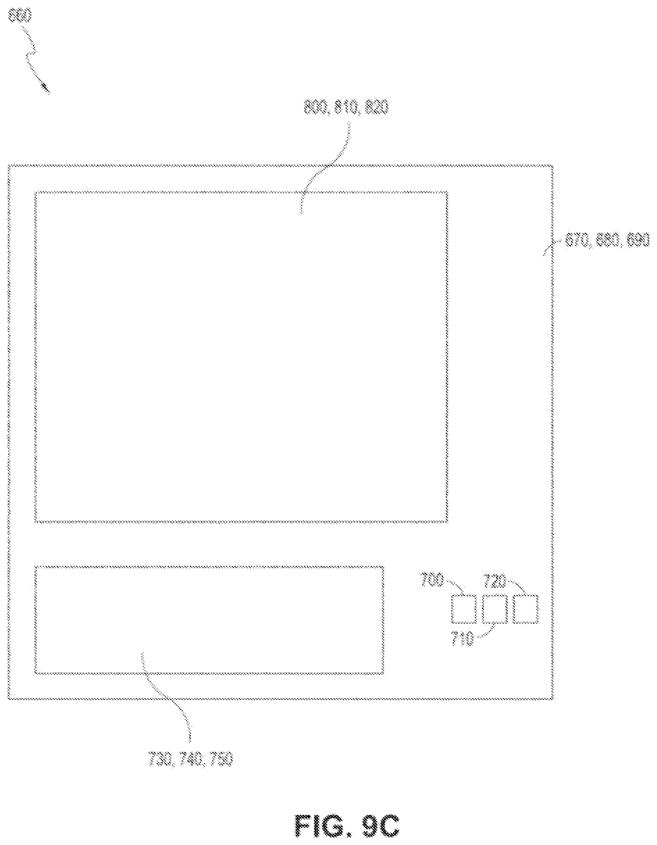

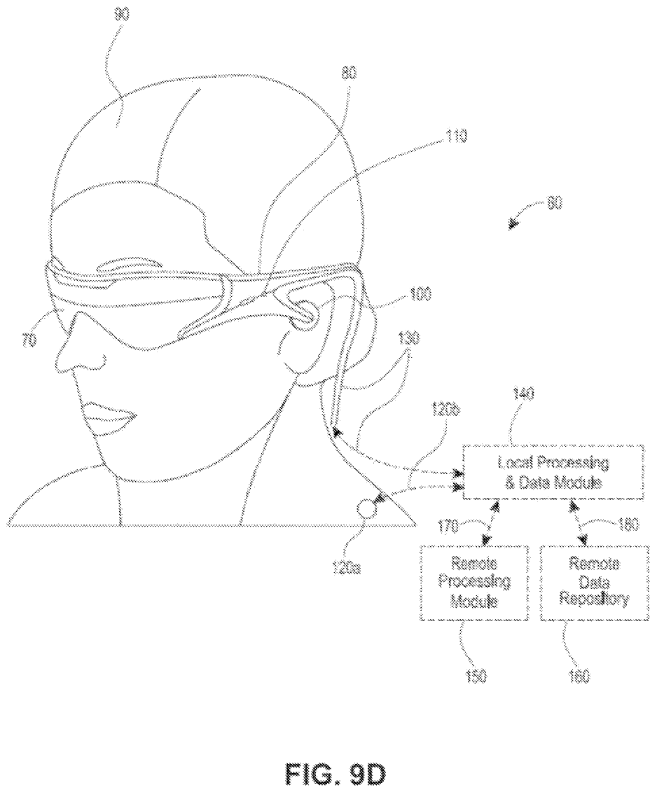

A controller 560 controls the operation of one or more of the stacked waveguide assembly 260, including operation of the image injection devices 360, 370, 380, 390, 400, the light source 530, and the light modulator 540. In some embodiments, the controller 560 is part of the local data processing module 140. The controller 560 includes programming (e.g., instructions in a non-transitory medium) that regulates the timing and provision of image information to the waveguides 270, 280, 290, 300, 310 according to, e.g., any of the various schemes disclosed herein. In some embodiments, the controller may be a single integral device, or a distributed system connected by wired or wireless communication channels. The controller 560 may be part of the processing modules 140 or 150 (FIG. 9D) in some embodiments.

With continued reference to FIG. 6, the waveguides 270, 280, 290, 300, 310 may be configured to propagate light within each respective waveguide by total internal reflection (TIR). The waveguides 270, 280, 290, 300, 310 may each be planar or have another shape (e.g., curved), with major top and bottom surfaces and edges extending between those major top and bottom surfaces. In the illustrated configuration, the waveguides 270, 280, 290, 300, 310 may each include out-coupling optical elements 570, 580, 590, 600, 610 that are configured to extract light out of a waveguide by redirecting the light, propagating within each respective waveguide, out of the waveguide to output image information to the eye 210. Extracted light may also be referred to as out-coupled light and the out-coupling optical elements light may also be referred to light extracting optical elements. An extracted beam of light may be outputted by the waveguide at locations at which the light propagating in the waveguide strikes a light extracting optical element. The out-coupling optical elements 570, 580, 590, 600, 610 may, for example, be gratings, including diffractive optical features, as discussed further herein. While illustrated disposed at the bottom major surfaces of the waveguides 270, 280, 290, 300, 310, for ease of description and drawing clarity, in some embodiments, the out-coupling optical elements 570, 580, 590, 600, 610 may be disposed at the top and/or bottom major surfaces, and/or may be disposed directly in the volume of the waveguides 270, 280, 290, 300, 310, as discussed further herein. In some embodiments, the out-coupling optical elements 570, 580, 590, 600, 610 may be formed in a layer of material that is attached to a transparent substrate to form the waveguides 270, 280, 290, 300, 310. In some other embodiments, the waveguides 270, 280, 290, 300, 310 may be a monolithic piece of material and the out-coupling optical elements 570, 580, 590, 600, 610 may be formed on a surface and/or in the interior of that piece of material.

With continued reference to FIG. 6, as discussed herein, each waveguide 270, 280, 290, 300, 310 is configured to output light to form an image corresponding to a particular depth plane. For example, the waveguide 270 nearest the eye may be configured to deliver collimated light (which was injected into such waveguide 270), to the eye 210. The collimated light may be representative of the optical infinity focal plane. The next waveguide up 280 may be configured to send out collimated light which passes through the first lens 350 (e.g., a negative lens) before it may reach the eye 210; such first lens 350 may be configured to create a slight convex wavefront curvature so that the eye/brain interprets light coming from that next waveguide up 280 as coming from a first focal plane closer inward toward the eye 210 from optical infinity. Similarly, the third up waveguide 290 passes its output light through both the first 350 and second 340 lenses before reaching the eye 210; the combined optical power of the first 350 and second 340 lenses may be configured to create another incremental amount of wavefront curvature so that the eye/brain interprets light coming from the third waveguide 290 as coming from a second focal plane that is even closer inward toward the person from optical infinity than was light from the next waveguide up 280.

The other waveguide layers 300, 310 and lenses 330, 320 are similarly configured, with the highest waveguide 310 in the stack sending its output through all of the lenses between it and the eye for an aggregate focal power representative of the closest focal plane to the person. To compensate for the stack of lenses 320, 330, 340, 350 when viewing/interpreting light coming from the world 510 on the other side of the stacked waveguide assembly 260, a compensating lens layer 620 may be disposed at the top of the stack to compensate for the aggregate power of the lens stack 320, 330, 340, 350 below. Such a configuration provides as many perceived focal planes as there are available waveguide/lens pairings. Both the out-coupling optical elements of the waveguides and the focusing aspects of the lenses may be static (i.e., not dynamic or electro-active). In some alternative embodiments, either or both may be dynamic using electro-active features.

In some embodiments, two or more of the waveguides 270, 280, 290, 300, 310 may have the same associated depth plane. For example, multiple waveguides 270, 280, 290, 300, 310 may be configured to output images set to the same depth plane, or multiple subsets of the waveguides 270, 280, 290, 300, 310 may be configured to output images set to the same plurality of depth planes, with one set for each depth plane. This may provide advantages for forming a tiled image to provide an expanded field of view at those depth planes.

With continued reference to FIG. 6, the out-coupling optical elements 570, 580, 590, 600, 610 may be configured to both redirect light out of their respective waveguides and to output this light with the appropriate amount of divergence or collimation for a particular depth plane associated with the waveguide. As a result, waveguides having different associated depth planes may have different configurations of out-coupling optical elements 570, 580, 590, 600, 610, which output light with a different amount of divergence depending on the associated depth plane. In some embodiments, the light extracting optical elements 570, 580, 590, 600, 610 may be volumetric or surface features, which may be configured to output light at specific angles. For example, the light extracting optical elements 570, 580, 590, 600, 610 may be volume holograms, surface holograms, and/or diffraction gratings. In some embodiments, the features 320, 330, 340, 350 may not be lenses; rather, they may simply be spacers (e.g., cladding layers and/or structures for forming air gaps).

In some embodiments, the out-coupling optical elements 570, 580, 590, 600, 610 are diffractive features that form a diffraction pattern, or “diffractive optical element” (also referred to herein as a “DOE”). Preferably, the DOE's have a sufficiently low diffraction efficiency so that only a portion of the light of the beam is deflected away toward the eye 210 with each intersection of the DOE, while the rest continues to move through a waveguide via TIR. The light carrying the image information is thus divided into a number of related exit beams that exit the waveguide at a multiplicity of locations and the result is a fairly uniform pattern of exit emission toward the eye 210 for this particular collimated beam bouncing around within a waveguide.

In some embodiments, one or more DOEs may be switchable between “on” states in which they actively diffract, and “off” states in which they do not significantly diffract. For instance, a switchable DOE may comprise a layer of polymer dispersed liquid crystal, in which microdroplets comprise a diffraction pattern in a host medium, and the refractive index of the microdroplets may be switched to substantially match the refractive index of the host material (in which case the pattern does not appreciably diffract incident light) or the microdroplet may be switched to an index that does not match that of the host medium (in which case the pattern actively diffracts incident light).

In some embodiments, a camera assembly 630 (e.g., a digital camera, including visible light and infrared light cameras) may be provided to capture images of the eye 210 and/or tissue around the eye 210 to, e.g., detect user inputs and/or to monitor the physiological state of the user. As used herein, a camera may be any image capture device. In some embodiments, the camera assembly 630 may include an image capture device and a light source to project light (e.g., infrared light) to the eye, which may then be reflected by the eye and detected by the image capture device. In some embodiments, the camera assembly 630 may be attached to the frame 80 (FIG. 9D) and may be in electrical communication with the processing modules 140 and/or 150, which may process image information from the camera assembly 630. In some embodiments, one camera assembly 630 may be utilized for each eye, to separately monitor each eye.

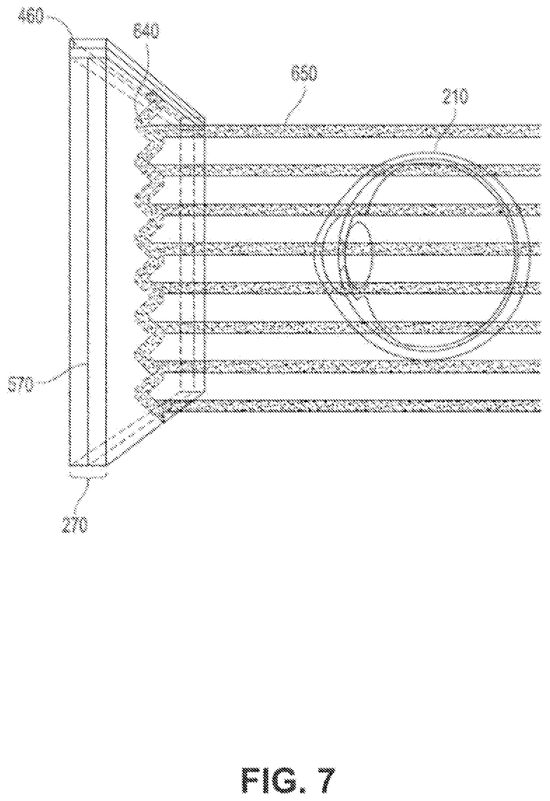

With reference now to FIG. 7, an example of exit beams outputted by a waveguide is shown. One waveguide is illustrated, but it will be appreciated that other waveguides in the waveguide assembly 260 (FIG. 6) may function similarly, where the waveguide assembly 260 includes multiple waveguides. Light 640 is injected into the waveguide 270 at the input surface 460 of the waveguide 270 and propagates within the waveguide 270 by TIR. At points where the light 640 impinges on the DOE 570, a portion of the light exits the waveguide as exit beams 650. The exit beams 650 are illustrated as substantially parallel but, as discussed herein, they may also be redirected to propagate to the eye 210 at an angle (e.g., forming divergent exit beams), depending on the depth plane associated with the waveguide 270. It will be appreciated that substantially parallel exit beams may be indicative of a waveguide with out-coupling optical elements that out-couple light to form images that appear to be set on a depth plane at a large distance (e.g., optical infinity) from the eye 210. Other waveguides or other sets of out-coupling optical elements may output an exit beam pattern that is more divergent, which would require the eye 210 to accommodate to a closer distance to bring it into focus on the retina and would be interpreted by the brain as light from a distance closer to the eye 210 than optical infinity.

In some embodiments, a full color image may be formed at each depth plane by overlaying images in each of the component colors, e.g., three or more component colors. FIG. 8 illustrates an example of a stacked waveguide assembly in which each depth plane includes images formed using multiple different component colors. The illustrated embodiment shows depth planes 240a-240f, although more or fewer depths are also contemplated. Each depth plane may have three or more component color images associated with it, including: a first image of a first color, G; a second image of a second color, R; and a third image of a third color, B. Different depth planes are indicated in the figure by different numbers for diopters (dpt) following the letters G, R, and B. Just as examples, the numbers following each of these letters indicate diopters (1/m), or inverse distance of the depth plane from a viewer, and each box in the figures represents an individual component color image. In some embodiments, to account for differences in the eye's focusing of light of different wavelengths, the exact placement of the depth planes for different component colors may vary. For example, different component color images for a given depth plane may be placed on depth planes corresponding to different distances from the user. Such an arrangement may increase visual acuity and user comfort and/or may decrease chromatic aberrations.

In some embodiments, light of each component color may be outputted by a single dedicated waveguide and, consequently, each depth plane may have multiple waveguides associated with it. In such embodiments, each box in the figures including the letters G, R, or B may be understood to represent an individual waveguide, and three waveguides may be provided per depth plane where three component color images are provided per depth plane. While the waveguides associated with each depth plane are shown adjacent to one another in this drawing for ease of description, it will be appreciated that, in a physical device, the waveguides may all be arranged in a stack with one waveguide per level. In some other embodiments, multiple component colors may be outputted by the same waveguide, such that, e.g., only a single waveguide may be provided per depth plane.

With continued reference to FIG. 8, in some embodiments, G is the color green, R is the color red, and B is the color blue. In some other embodiments, other colors associated with other wavelengths of light, including magenta and cyan, may be used in addition to or may replace one or more of red, green, or blue.

It will be appreciated that references to a given color of light throughout this disclosure will be understood to encompass light of one or more wavelengths within a range of wavelengths of light that are perceived by a viewer as being of that given color. For example, red light may include light of one or more wavelengths in the range of about 620-780 nm, green light may include light of one or more wavelengths in the range of about 492-577 nm, and blue light may include light of one or more wavelengths in the range of about 435-493 nm.

In some embodiments, the light source 530 (FIG. 6) may be configured to emit light of one or more wavelengths outside the visual perception range of the viewer, for example, infrared and/or ultraviolet wavelengths. In addition, the in-coupling, out-coupling, and other light redirecting structures of the waveguides of the display 250 may be configured to direct and emit this light out of the display towards the user's eye 210, e.g., for imaging and/or user stimulation applications.

With reference now to FIG. 9A, in some embodiments, light impinging on a waveguide may need to be redirected to in-couple that light into the waveguide. An in-coupling optical element may be used to redirect and in-couple the light into its corresponding waveguide. FIG. 9A illustrates a cross-sectional side view of an example of a plurality or set 660 of stacked waveguides that each includes an in-coupling optical element. The waveguides may each be configured to output light of one or more different wavelengths, or one or more different ranges of wavelengths. It will be appreciated that the stack 660 may correspond to the stack 260 (FIG. 6) and the illustrated waveguides of the stack 660 may correspond to part of the plurality of waveguides 270, 280, 290, 300, 310, except that light from one or more of the image injection devices 360, 370, 380, 390, 400 is injected into the waveguides from a position that requires light to be redirected for in-coupling.

The illustrated set 660 of stacked waveguides includes waveguides 670, 680, and 690. Each waveguide includes an associated in-coupling optical element (which may also be referred to as a light input area on the waveguide), with, e.g., in-coupling optical element 700 disposed on a major surface (e.g., an upper major surface) of waveguide 670, in-coupling optical element 710 disposed on a major surface (e.g., an upper major surface) of waveguide 680, and in-coupling optical element 720 disposed on a major surface (e.g., an upper major surface) of waveguide 690. In some embodiments, one or more of the in-coupling optical elements 700, 710, 720 may be disposed on the bottom major surface of the respective waveguide 670, 680, 690 (particularly where the one or more in-coupling optical elements are reflective, deflecting optical elements). As illustrated, the in-coupling optical elements 700, 710, 720 may be disposed on the upper major surface of their respective waveguide 670, 680, 690 (or the top of the next lower waveguide), particularly where those in-coupling optical elements are transmissive, deflecting optical elements. In some embodiments, the in-coupling optical elements 700, 710, 720 may be disposed in the body of the respective waveguide 670, 680, 690. In some embodiments, as discussed herein, the in-coupling optical elements 700, 710, 720 are wavelength selective, such that they selectively redirect one or more wavelengths of light, while transmitting other wavelengths of light. While illustrated on one side or corner of their respective waveguide 670, 680, 690, it will be appreciated that the in-coupling optical elements 700, 710, 720 may be disposed in other areas of their respective waveguide 670, 680, 690 in some embodiments.

As illustrated, the in-coupling optical elements 700, 710, 720 may be laterally offset from one another. In some embodiments, each in-coupling optical element may be offset such that it receives light without that light passing through another in-coupling optical element. For example, each in-coupling optical element 700, 710, 720 may be configured to receive light from a different image injection device 360, 370, 380, 390, and 400 as shown in FIG. 6, and may be separated (e.g., laterally spaced apart) from other in-coupling optical elements 700, 710, 720 such that it substantially does not receive light from the other ones of the in-coupling optical elements 700, 710, 720.

Each waveguide also includes associated light distributing elements, with, e.g., light distributing elements 730 disposed on a major surface (e.g., a top major surface) of waveguide 670, light distributing elements 740 disposed on a major surface (e.g., a top major surface) of waveguide 680, and light distributing elements 750 disposed on a major surface (e.g., a top major surface) of waveguide 690. In some other embodiments, the light distributing elements 730, 740, 750, may be disposed on a bottom major surface of associated waveguides 670, 680, 690, respectively. In some other embodiments, the light distributing elements 730, 740, 750, may be disposed on both top and bottom major surface of associated waveguides 670, 680, 690, respectively; or the light distributing elements 730, 740, 750, may be disposed on different ones of the top and bottom major surfaces in different associated waveguides 670, 680, 690, respectively.

The waveguides 670, 680, 690 may be spaced apart and separated by, e.g., gas, liquid, and/or solid layers of material. For example, as illustrated, layer 760a may separate waveguides 670 and 680; and layer 760b may separate waveguides 680 and 690. In some embodiments, the layers 760a and 760b are formed of low refractive index materials (that is, materials having a lower refractive index than the material forming the immediately adjacent one of waveguides 670, 680, 690). Preferably, the refractive index of the material forming the layers 760a, 760b is 0.05 or more, or 0.10 or less than the refractive index of the material forming the waveguides 670, 680, 690. Advantageously, the lower refractive index layers 760a, 760b may function as cladding layers that facilitate total internal reflection (TIR) of light through the waveguides 670, 680, 690 (e.g., TIR between the top and bottom major surfaces of each waveguide). In some embodiments, the layers 760a, 760b are formed of air. While not illustrated, it will be appreciated that the top and bottom of the illustrated set 660 of waveguides may include immediately neighboring cladding layers.

Preferably, for ease of manufacturing and other considerations, the material forming the waveguides 670, 680, 690 are similar or the same, and the material forming the layers 760a, 760b are similar or the same. In some embodiments, the material forming the waveguides 670, 680, 690 may be different between one or more waveguides, and/or the material forming the layers 760a, 760b may be different, while still holding to the various refractive index relationships noted above.

With continued reference to FIG. 9A, light rays 770, 780, 790 are incident on the set 660 of waveguides. It will be appreciated that the light rays 770, 780, 790 may be injected into the waveguides 670, 680, 690 by one or more image injection devices 360, 370, 380, 390, 400 (FIG. 6).

In some embodiments, the light rays 770, 780, 790 have different properties, e.g., different wavelengths or different ranges of wavelengths, which may correspond to different colors. The in-coupling optical elements 700, 710, 720 each deflect the incident light such that the light propagates through a respective one of the waveguides 670, 680, 690 by TIR. In some embodiments, the incoupling optical elements 700, 710, 720 each selectively deflect one or more particular wavelengths of light, while transmitting other wavelengths to an underlying waveguide and associated incoupling optical element.

For example, in-coupling optical element 700 may be configured to deflect ray 770, which has a first wavelength or range of wavelengths, while transmitting rays 780 and 790, which have different second and third wavelengths or ranges of wavelengths, respectively. The transmitted ray 780 impinges on and is deflected by the in-coupling optical element 710, which is configured to deflect light of a second wavelength or range of wavelengths. The ray 790 is deflected by the in-coupling optical element 720, which is configured to selectively deflect light of third wavelength or range of wavelengths.

With continued reference to FIG. 9A, the deflected light rays 770, 780, 790 are deflected so that they propagate through a corresponding waveguide 670, 680, 690; that is, the in-coupling optical elements 700, 710, 720 of each waveguide deflects light into that corresponding waveguide 670, 680, 690 to in-couple light into that corresponding waveguide. The light rays 770, 780, 790 are deflected at angles that cause the light to propagate through the respective waveguide 670, 680, 690 by TIR. The light rays 770, 780, 790 propagate through the respective waveguide 670, 680, 690 by TIR until impinging on the waveguide's corresponding light distributing elements 730, 740, 750.

With reference now to FIG. 9B, a perspective view of an example of the plurality of stacked waveguides of FIG. 9A is illustrated. As noted above, the in-coupled light rays 770, 780, 790, are deflected by the in-coupling optical elements 700, 710, 720, respectively, and then propagate by TIR within the waveguides 670, 680, 690, respectively. The light rays 770, 780, 790 then impinge on the light distributing elements 730, 740, 750, respectively. The light distributing elements 730, 740, 750 deflect the light rays 770, 780, 790 so that they propagate towards the out-coupling optical elements 800, 810, 820, respectively.

In some embodiments, the light distributing elements 730, 740, 750 are orthogonal pupil expanders (OPE's). In some embodiments, the OPE's deflect or distribute light to the out-coupling optical elements 800, 810, 820 and, in some embodiments, may also increase the beam or spot size of this light as it propagates to the out-coupling optical elements. In some embodiments, the light distributing elements 730, 740, 750 may be omitted and the in-coupling optical elements 700, 710, 720 may be configured to deflect light directly to the out-coupling optical elements 800, 810, 820. For example, with reference to FIG. 9A, the light distributing elements 730, 740, 750 may be replaced with out-coupling optical elements 800, 810, 820, respectively. In some embodiments, the out-coupling optical elements 800, 810, 820 are exit pupils (EP's) or exit pupil expanders (EPE's) that direct light in a viewer's eye 210 (FIG. 7). It will be appreciated that the OPE's may be configured to increase the dimensions of the eye box in at least one axis and the EPE's may be to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EP again, at which time another portion of the impinging light is directed out of the waveguide, and so on. Consequently, a single beam of incoupled light may be “replicated” each time a portion of that light is redirected by an OPE or EPE, thereby forming a field of cloned beams of light, as shown in FIG. 6. In some embodiments, the OPE and/or EPE may be configured to modify a size of the beams of light.

Accordingly, with reference to FIGS. 9A and 9B, in some embodiments, the set 660 of waveguides includes waveguides 670, 680, 690; in-coupling optical elements 700, 710, 720; light distributing elements (e.g., OPE's) 730, 740, 750; and out-coupling optical elements (e.g., EP's) 800, 810, 820 for each component color. The waveguides 670, 680, 690 may be stacked with an air gap/cladding layer between each one. The in-coupling optical elements 700, 710, 720 redirect or deflect incident light (with different in-coupling optical elements receiving light of different wavelengths) into its waveguide. The light then propagates at an angle which will result in TIR within the respective waveguide 670, 680, 690. In the example shown, light ray 770 (e.g., blue light) is deflected by the first in-coupling optical element 700, and then continues to bounce down the waveguide, interacting with the light distributing element (e.g., OPE's) 730 and then the out-coupling optical element (e.g., EPs) 800, in a manner described earlier. The light rays 780 and 790 (e.g., green and red light, respectively) will pass through the waveguide 670, with light ray 780 impinging on and being deflected by in-coupling optical element 710. The light ray 780 then bounces down the waveguide 680 via TIR, proceeding on to its light distributing element (e.g., OPEs) 740 and then the out-coupling optical element (e.g., EP's) 810. Finally, light ray 790 (e.g., red light) passes through the waveguide 690 to impinge on the light in-coupling optical elements 720 of the waveguide 690. The light in-coupling optical elements 720 deflect the light ray 790 such that the light ray propagates to light distributing element (e.g., OPEs) 750 by TIR, and then to the out-coupling optical element (e.g., EPs) 820 by TIR. The out-coupling optical element 820 then finally out-couples the light ray 790 to the viewer, who also receives the out-coupled light from the other waveguides 670, 680.

FIG. 9C illustrates a top-down plan view of an example of the plurality of stacked waveguides of FIGS. 9A and 9B. As illustrated, the waveguides 670, 680, 690, along with each waveguide's associated light distributing element 730, 740, 750 and associated out-coupling optical element 800, 810, 820, may be vertically aligned. However, as discussed herein, the in-coupling optical elements 700, 710, 720 are not vertically aligned; rather, the in-coupling optical elements are non-overlapping (e.g., laterally spaced apart as seen in the top-down view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially-separated in-coupling optical elements may be referred to as a shifted pupil system, and the in-coupling optical elements within these arrangements may correspond to sub pupils.

Alternatively, in certain embodiments, two or more of the in-coupling optical elements can be in an inline arrangement, in which they are vertically aligned. In such arrangements, light for waveguides further from the projection system is transmitted through the in-coupling optical elements for waveguides closer to the projection system, preferably with minimal scattering or diffraction.

Inline configurations can advantageously reduce the size of and simplify the projector. Moreover, it can increase the field of view of the eyepiece, e.g., by coupling of same color to several waveguides by making use of crosstalk. For example, green light can be coupled into blue and red active layers. Because of the pitch of each ICG can be different to provide improved (e.g., optimal) performance for a specific color, the allowed field of view can be increased.

In inline configurations, except for the last layer in the optical path, the ICGs should be either at most partially reflective or otherwise transmissive to light having operative wavelengths of subsequent layers in the waveguide stack. In either case, the efficiency can be undesirably low unless the gratings are etched in a high index layer (e.g., 1.8 or more for polymer based layers), or a high index coating is deposited or growth on the grating. However, this approach can increase the back reflection into the projector lens, which thus can generate image artifacts such as image ghosting.

FIG. 9D illustrates an example of wearable display system 60 into which the various waveguides and related systems disclosed herein may be integrated. In some embodiments, the display system 60 is the system 250 of FIG. 6, with FIG. 6 schematically showing some parts of that system 60 in greater detail. For example, the waveguide assembly 260 of FIG. 6 may be part of the display 70.

With continued reference to FIG. 9D, the display system 60 includes a display 70, and various mechanical and electronic modules and systems to support the functioning of that display 70. The display 70 may be coupled to a frame 80, which is wearable by a display system user or viewer 90 and which is configured to position the display 70 in front of the eyes of the user 90. The display 70 may be considered eyewear in some embodiments. In some embodiments, a speaker 100 is coupled to the frame 80 and configured to be positioned adjacent the ear canal of the user 90 (in some embodiments, another speaker, not shown, may optionally be positioned adjacent the other ear canal of the user to provide stereo/shapeable sound control). The display system 60 may also include one or more microphones 110 or other devices to detect sound. In some embodiments, the microphone is configured to allow the user to provide inputs or commands to the system 60 (e.g., the selection of voice menu commands, natural language questions, etc.), and/or may allow audio communication with other persons (e.g., with other users of similar display systems. The microphone may further be configured as a peripheral sensor to collect audio data (e.g., sounds from the user and/or environment). In some embodiments, the display system may also include a peripheral sensor 120a, which may be separate from the frame 80 and attached to the body of the user 90 (e.g., on the head, torso, an extremity, etc. of the user 90). The peripheral sensor 120a may be configured to acquire data characterizing a physiological state of the user 90 in some embodiments. For example, the sensor 120a may be an electrode.

With continued reference to FIG. 9D, the display 70 is operatively coupled by communications link 130, such as by a wired lead or wireless connectivity, to a local data processing module 140 which may be mounted in a variety of configurations, such as fixedly attached to the frame 80, fixedly attached to a helmet or hat worn by the user, embedded in headphones, or otherwise removably attached to the user 90 (e.g., in a backpack-style configuration, in a belt-coupling style configuration). Similarly, the sensor 120a may be operatively coupled by communications link 120b, e.g., a wired lead or wireless connectivity, to the local processor and data module 140. The local processing and data module 140 may comprise a hardware processor, as well as digital memory, such as non-volatile memory (e.g., flash memory or hard disk drives), both of which may be utilized to assist in the processing, caching, and storage of data. Optionally, the local processor and data module 140 may include one or more central processing units (CPUs), graphics processing units (GPUs), dedicated processing hardware, and so on. The data may include data a) captured from sensors (which may be, e.g., operatively coupled to the frame 80 or otherwise attached to the user 90), such as image capture devices (such as cameras), microphones, inertial measurement units, accelerometers, compasses, GPS units, radio devices, gyros, and/or other sensors disclosed herein; and/or b) acquired and/or processed using remote processing module 150 and/or remote data repository 160 (including data relating to virtual content), possibly for passage to the display 70 after such processing or retrieval. The local processing and data module 140 may be operatively coupled by communication links 170, 180, such as via a wired or wireless communication links, to the remote processing module 150 and remote data repository 160 such that these remote modules 150, 160 are operatively coupled to each other and available as resources to the local processing and data module 140. In some embodiments, the local processing and data module 140 may include one or more of the image capture devices, microphones, inertial measurement units, accelerometers, compasses, GPS units, radio devices, and/or gyros. In some other embodiments, one or more of these sensors may be attached to the frame 80, or may be standalone structures that communicate with the local processing and data module 140 by wired or wireless communication pathways.

With continued reference to FIG. 9D, in some embodiments, the remote processing module 150 may comprise one or more processors configured to analyze and process data and/or image information, for instance including one or more central processing units (CPUs), graphics processing units (GPUs), dedicated processing hardware, and so on. In some embodiments, the remote data repository 160 may comprise a digital data storage facility, which may be available through the internet or other networking configuration in a “cloud” resource configuration. In some embodiments, the remote data repository 160 may include one or more remote servers, which provide information, e.g., information for generating augmented reality content, to the local processing and data module 140 and/or the remote processing module 150. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, modules 140, 150, 160, for instance via wireless or wired connections.

### Diffractive Structures for Asymmetric Light Extraction

Providing a high quality immersive experience to a user of waveguide-based display systems such as various display systems configured for virtual/augmented/mixed display applications described above, depends on, among other things, various characteristics of the light coupling into and/or out of the waveguides in the eyepiece of the display systems. For example, a virtual/augmented/mixed display having high light incoupling and outcoupling efficiencies can enhance the viewing experience by increasing brightness of the light directed to the user's eye. As discussed above, in-coupling optical elements such as in-coupling diffraction gratings can be used to couple light into the waveguides to be guided therein by total internal reflection. Similarly, out-coupling optical elements such as out-coupling diffraction gratings can be used to couple light guided within the waveguides by total internal reflection out of the waveguides.

As described above, e.g., in reference to FIGS. 6 and 7, display systems described herein can include optical elements, e.g., in-coupling optical elements, out-coupling optical elements, light distributing elements, and/or combined pupil expander-extractors (CPEs) that include diffraction gratings. A CPE can operate both as a light distributing element spreading or distributing light within the waveguide, possibly increasing beam size and/or the eye box, as well as an out-coupling optical element coupling light out of the waveguide.

For example, as described above in reference to FIG. 7, light 640 that is injected into the waveguide 270 at the input surface 460 of the waveguide 270 propagates and is guided within the waveguide 270 by total internal reflection (TIR). In various implementation, at points where the light 640 impinges on the out-coupling optical element 570, a portion of the light guided within the waveguide may exit the waveguide as beamlets 650. In some implementations, any of the optical elements 570, 580, 590, 600, 610, which may include one or more of an incoupling optical element, an outcoupling optical element, a light distribution element or a CPE, can be configured as a diffraction grating.

To achieve desirable characteristics of in-coupling of light into and/or out-coupling of light from the waveguides 270, 280, 290, 300, 310, the optical elements 570, 580, 590, 600, 610 configured as diffraction gratings can be formed of a suitable material and have a suitable structure for controlling various optical properties, including diffraction properties such as diffraction efficiency as a function of polarization. Possible desirable diffraction properties may include, among other properties, any one or more of the following: spectral selectivity, angular selectivity, polarization selectivity (or non-selectivity), high spectral bandwidth, high diffraction efficiencies or a wide field of view (FOV).

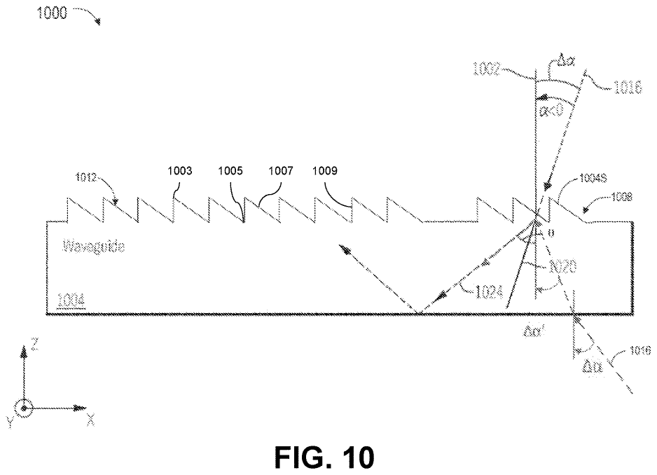

FIG. 10 illustrates a cross-sectional view of a portion of a display device 1000 such as an eyepiece having a waveguide 1004 and a blazed diffraction grating 1008 formed on the substrate that is a waveguide 1004, according to some designs described herein. In the implementation shown, the blazed diffraction grating 1008 is formed in the substrate/waveguide 1004 (which, in this example, is planar). The surface of the substrate or waveguide 1004 has a surface topography including diffractive features that together form the diffraction grating 1008. The blazed diffraction grating 1008 is configured to diffract light having a wavelength in the visible spectrum such that the light incident thereon is guided within the waveguide 1004 by TIR. The waveguide 1004 may be transparent and may form part of an eyepiece through which a user's eye can see. Such a waveguide 1004 and eyepiece may be include in a head mounted display such as an augmented reality display. The waveguide 1004 can correspond, for example, to one of waveguides 670, 680, 690 described above with respect to FIGS. 9A-9C, for example. The blazed diffraction grating 1008 can correspond to one of the in-coupling optical elements 700, 710, 720 described above with respect to FIGS. 9A-9C, for example. The blazed diffraction grating 1008 configured to in-couple light into the waveguide 1004 may be referred to herein as an in-coupling grating (ICG). The display device 1000 may additionally include an optical element 1012, that can correspond, for example, to a light distributing element (e.g., one of the light distributing elements 730, 740, 750 shown in FIGS. 9A-9C), or an out-coupling optical element (e.g., one of the out-coupling optical elements 800, 810, 820 shown in FIGS. 9A-9C).

In operation, when an incident light beam 1016, e.g., visible light, such as from a light projection system that provide image content is incident on the blazed diffraction grating 1008 at an angle of incidence, α, measured relative to a plane normal 1002 that is normal or orthogonal to the extended surface or plane of the blazed diffraction grating or the substrate/waveguide and/or the surface 1004S of the waveguide 1004, for example, a major surface of the waveguide on which the grating is formed (shown in FIG. 10 as extending parallel to the y-x plane), the blazed diffraction grating at least partially diffracts the incident light beam 1016 as a diffracted light beam 1024 at a diffraction angle θ measured relative to the plane normal 1002. When the diffracted light beam 1024 is diffracted at a diffraction angle θ that exceeds a critical angle θTIR for occurrence of total internal reflection in the waveguide 1004, the diffracted light beam 1024 propagates and is guided within the waveguide 1004 via total internal reflection (TIR) generally along a direction parallel to the x-axis and along the length of the waveguide. A portion of this light guided within the waveguide 1004 may reach one of light distributing elements 730, 740, 750 or one of out-coupling optical elements (800, 810, 820, FIGS. 9A-9C), for example, and be diffracted again.

As described herein, a light beam that is incident at an angle in a clockwise direction relative to the plane normal 1002 (i.e., on the right side of the plane normal 1002) as in the illustrated implementation is referred to as having a negative α (α<0), whereas a light beam that is incident at an angle in a counter-clockwise direction relative to the plane normal 1002 (i.e., on the left side of the plane normal) is referred to as having a positive α (α>0).

A suitable combination of high index material and/or the structure of the diffraction grating 1008 may result in a particular range (Δα) of angle of incidence α, referred to herein as a range of angles of acceptance or a field-of-view (FOV). One range, Δα, may be described by a range of angles spanning negative and/or positive values of α, outside of which the diffraction efficiency falls off by more than 10%, 25%, more than 50%, or more than 75%, 80%, 90%, 95%, or any value in a range defined by any of these values, relative to the diffraction efficiency at α=0 or some other direction. In some implementations, having Au within the range in which the diffraction efficiency is relatively high and constant may be desirable, e.g., where a uniform intensity of diffracted light is desired within the AU. Thus, in some implementations, Δα is associated with the angular bandwidth of the diffraction grating 1008, such that an incident light beam 1016 within the Δα is efficiently diffracted by the diffraction grating 1008 at a diffraction angle θ with respect to the surface normal 1002 (e.g., a direction parallel to the y-z plane) wherein θ exceeds θTIR such that the diffracted light is guided within the waveguide 1004 under total internal reflection (TIR). In some implementations, this angle Δα range may affect the field-of-view seen by the user. It will be appreciated that, in various implementations, the light can be directed onto the in-coupling grating (ICG) from either side. For example, the light can be directed through the substrate or waveguide 1004 and be incident onto a reflective in-coupling grating (ICG) 1008 such as the one shown in FIG. 10. The light may undergo the same effect, e.g., be coupled into the substrate or waveguide 1004 by the in-coupling grating 1008 such that the light is guided within substrate or waveguide by total internal reflection. The range (Δα) of angle of incidence α, referred to herein as a range of angles of acceptance or a field-of-view (FOV) may be effected by the index of refraction of the substrate or waveguide material. In FIG. 10, for example, a reduced range of angles (Δα′), shows the effects of refraction of the high index material on the light incident on the in-coupling grating (ICG). The range of angles (Δα) or FOV, however, is larger.

The gratings 1008 and 1012 both include grating features having peaks 1003 and grooves 1005. The blazed transmission grating 1008 includes a surface corresponding to the surface of the substrate or waveguide 1004S having a “sawtooth” shape pattern as viewed from the cross-section shown. The “sawtooth” patterned is formed by first sloping portions 1007 of the surface 1004S. In the example shown in FIG. 10, the grating 1008 also includes second (steeper) sloping portions 1009. In the example shown, the first sloping portions 1007 have a shallower inclination than the second sloping portions 1009, which have a steeper inclination. The first sloping portions 1007 also are wider than the second sloping portions 1009 in this example.

When configured as an in-coupling optical element or an in-coupling diffraction grating, the diffraction grating 1008 can diffractively couple light incident into the substrate 1004, which can be a waveguide as described above. The diffraction grating 1012 is configured as an out-coupling optical element and diffractively couples light from the substrate 1004, which can be a waveguide also as described above.

The substrate 1004 can be formed from a high index material, e.g., having an index of refraction of at least 1.7. The index of refraction, for example, can be at least 1.8, at least 1.9, at least 2.0, at least 2.1, at least 2.2, or at least 2.3 and may be no more than 2.4, 2.5, 2.6, 2.7, 2.8, or may be in any range formed by any of these values or may be outside these ranges. In some implementations, for example, the substrate comprises a Li-based oxide. In various examples disclosed herein, the diffractive features of the diffractive grating 1008 may be formed at a surface of the substrate 1004. The diffractive features may either be formed in the substrate 1004, e.g., a waveguide, or in a separate layer formed over the substrate 1004, e.g., a waveguide, and configured to optically communicate with the substrate 1004, e.g., couple light into or out of the substrate 1004. In the illustrated example, the diffractive features of the diffraction grating 1008 such as lines are formed in the substrate 1004 such as in the surface of the substrate. The diffractive features, for example, may be etched into the substrate 1004 having high index material such as a Li-based oxide. The substrate may, for example, include lithium niobate and the diffractive grating may be formed in the lithium niobate substrate by etching or patterning the surface of the substrate. Other materials having high refractive index may also be used. For example, other materials including lithium such as lithium oxides, e.g., lithium tantalate (LiTaO₃) may be employed as a substrate. Silicon carbide (SiC) is another option for the substrate material. Examples are not so limited. In other examples, the diffractive features of the diffractive grating 1008 may be formed in a separate layer disposed over, e.g., physically contacting, the substrate 1004. For example, a thin film coating of under 200 nm thickness of zinc oxide (ZnO), silicon nitride (Si₃N₄), zirconium dioxide (ZrO₂), titanium dioxide (TiO₂), silicon carbide (SiC), etc., may be disposed over an existing high index substrate. The thin film coating may be patterned to form the diffractive features. In some implementations, however, diffractive features, such as lines, of a diffraction grating 1008 may be formed of a material different from that of the substrate. The substrate may, for example, comprise a high index material such as a Li-based oxide (e.g., lithium niobate, LiNbO₃, or lithium tantalate, LiTaO₃), however, the diffractive features may be formed from a different material such as coatings of zinc oxide (ZnO), zirconium dioxide (ZrO₂), titanium dioxide (TiO₂), silicon carbide (SiC) or other materials described herein. In some implementations, this other material formed on the substrate may have a lower index of refraction. In some cases, the substrate 1004 can include, for example, materials (including amorphous high index glass substrates) such as materials based on silica glass (e.g., doped silica glass), silicon oxynitride, transition metal oxides (e.g., hafnium oxide, tantalum oxide, zirconium oxide, niobium oxide, aluminum oxide (e.g., sapphire)), plastic, a polymer, or other materially optically transmissive to visible light having, e.g., a suitable refractive index as described above, that is different from the material of the Li-based oxide features 1008.

In some examples, the diffraction gratings 1008 and 1012 and the substrate 1004 or waveguide both comprise the same material, e.g., a Li-based oxide. In some implementations, the diffraction gratings 1008 and 1012 are patterned directly into the substrate 1004, such that the diffraction gratings and the substrate 1004 form a single piece or a monolithic structure. For example, the substrate 1004 includes a waveguide having the diffraction grating 1008 formed directly in the surface of the waveguide or substrate. In these implementations, a bulk Li-based oxide material may be patterned at the surface 1004S to form the diffraction gratings 1008, while the Li-based oxide material below the diffraction gratings 1008 may form a waveguide. In yet some other implementations, the bulk or substrate 1004 and the surface 1004S patterned to form the diffraction gratings 1008 comprise different Li-based oxides. For example, a bulk Li-based oxide material patterned at the surface region to form the diffraction gratings 1008 may be formed of a first Li-based oxide material, while the Li-based oxide material below the diffraction gratings 1008 that form the substrate 1004 or the substrate region may be formed of a second Li-based oxide material different from the first Li-based oxide material. In certain examples, the diffraction gratings 1008 and 1012 are composed of different high-index material such as zirconium dioxide (ZrO2), titanium dioxide (TiO2), silicon carbide (SiC), etc. and the material below the diffraction gratings that form the substrate 1004 or the substrate region may be formed of a second material such as LiTaO3, LiNbO3, etc. and different from the first material coated as a thin film.

In the illustrated example in FIG. 10, the diffraction gratings 1008 and 1012 include multiple blazed diffraction grating ridges (or lines) that are elongated in a first horizontal direction or the y-direction and periodically repeat in a second horizontal direction or the x-direction. The diffraction grating lines can be, e.g., straight and continuous lines extending in the y-direction. However, embodiments are not so limited. In some implementations, the diffraction grating lines can be discontinuous lines, e.g., in the y direction. In some other implementations, the discontinuous lines can form a plurality of pillars protruding from a surface of the grating substrate. In some implementations, at least some of the diffraction grating lines can have different widths in the x-direction.

In the illustrated example, the diffraction grating lines of the diffraction grating 1008 have a profile, e.g., a sawtooth profile, having asymmetric opposing side surfaces forming different angles with respect to a plane of the substrate. However, embodiments are not so limited and in other implementations, the diffraction grating lines can have symmetric opposing side surfaces forming similar angles with respect to a plane of the substrate.

In general, it is believed that using one or more gratings with directional surface features for an EPE/CPE structure can preferentially extract light from a waveguide toward the user side, rather than extracting light equally towards both the world and user sides. Such structures can improve the overall efficiency of the system 25% or more (e.g., 50% or more, 75% or more, 100% or more, 150% or more, 200% or more, 300% or more, 400% or more, 500% or more, 600% or more, 700% or more, 800% or more, 900% or more, 1,000% or more, e.g., 2,000% or less, 1,500% or less).

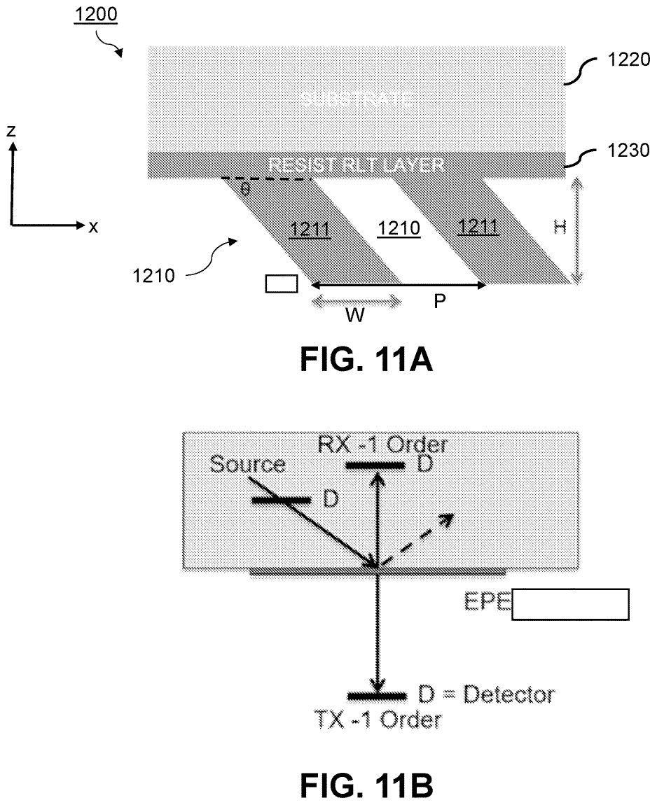

Referring to FIG. 11A, an example EPE/CPE 1200 (shown in cross-section) includes a slanted grating 1210 on a resist RLT layer 1230 supported by a substrate 1220. Slanted grating 1210 is composed of slanted ridges 1211 separated by trenches 1212.

The height of the grating layer refers to the ridge dimension along the z-direction and is denoted H. The ridge 1211 can have a height in a range from 10 nm to 1,000 nm (e.g., 50 nm to 500 nm, 100 nm to 400 nm, 200 nm to 400 nm, 250 nm to 350 nm).

The pitch of the grating layer, P, is the dimension along the x-direction between adjacent ridges or adjacent trenches. In general, the pitch, like the other parameters for grating structure 1210, can be determined empirically and/or through simulations. The pitch can be adjusted according to the operative wavelength(s) for the grating. In general, the pitch is in a range from 100 nm to 5,000 nm (e.g., 100 nm to 2,500 nm, 100 nm to 1,000 nm, 200 nm to 750 nm, 250 nm to 500 nm, 300 nm to 400 nm).

The ridges 1211 have a width, W, which refers to the ridge dimension along x-direction. For grating structure 1210, the opposing slopes of ridge 1211 through the cross-section illustrated are parallel, so the ridge thickness is constant for the ridge through its height. However, it is possible in certain implementations for the width to vary (e.g., narrow) from the base of the ridge to the top. In embodiments where the width varies, the width can be determined at the midpoint of the ridge's height.

The duty cycle refers to the ratio of the width to the pitch, expressed as a percentage. In embodiments, the grating structure can have a duty cycle in a range from 5% to 95% (e.g., 10% to 75%, 20% to 50%, 30% to 40%).

While the foregoing example is of a grating structure with a ridge that is a parallelogram in shape, more generally, other blazed or slanted cross-sectional shapes are possible. For example, generally trapezoidal, triangular, and stepped shapes, which can include curved shapes, e. g., a “shark fin”, “sawtooth,” and other tilted or slanted (i.e., non-rectangular) geometrical shapes, are also possible. Moreover, while the shape is depicted a corresponding to the shape of a parallelogram with mathematical precision, deviations from these shapes is inevitable due to manufacturing limitations, etc. In general, as used herein, such a ridge and other features are considered to have a particular shape where either their design prescribes such a shape and/or the structure has such a shape within the capabilities of the processes used to manufacture such structures at scale. Examples of other possible shapes are described below.

Without wishing to be bound by theory, and by way of example, the optical performance of a structure like EPE 1200 was simulated to demonstrate the asymmetric light extraction properties of such a device. Referring to FIG. 11B, optical properties of first order diffracted light resulting from light incident on the EPE from within the waveguide at a glancing angle, θ_{I}, was simulated. θ_{I} was selected so that the first order diffracted light propagated normal to the plane of the EPE (as shown). These rays represent the center portion of the user Field Of View (FOV). As shown in FIG. 11B, diffraction results in a reflected-1 (RX-1) order a transmitted 1 (TX-1) order.

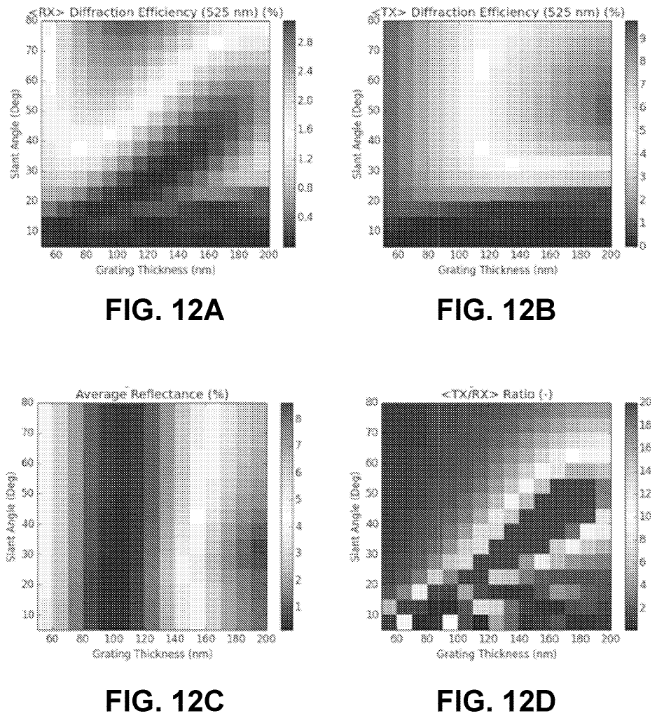

Referring to FIGS. 12A-12D, a parameter sweep of an EPE structure as depicted in FIG. 11A was performed for light having a 525 nm wavelength, for the incident condition discussed above, to identify structures that provide directionality. For this simulation, the duty cycle was set at 50% and grating thickness H and slant angle θ were varied. For each plot, grating thickness is the x-axis parameter and slant angle is the y-axis parameter. Grating thickness was varied from 60 nm to 200 nm and slant angle from 10° to 80°. In each case, the resist layer had a thickness of 10 nm. The four metrics used for analysis were: average (over polarization S/P) RX-1 diffraction efficiency <RX-1> ((FIG. 12A); average TX-1 diffraction efficiency <TX-1> (FIG. 12B); average reflectance (FIG. 12C); and d)<TX-1>/<RX-1> ratio for estimating directionality (FIG. 12D).

It was observed that values for <TX-1>/<RX-1> exceed a ratio of 10 for a band of thicknesses/slant angles increasing approximately linearly from about 100 nm and 20° to about 180 nm and about 50°. However, largest diffraction efficiencies (e.g., 5% or more) for transmitted light (<TX-1>) occur at higher thickness values (e.g., 120 nm or more) and higher slant angles (e.g., 40° or more). Generally, diffraction efficiency of transmitted light should be sufficiently high to ensure image uniformity over the FOV. While the simulations reported here are simply examples and not intended to be limiting, they provide an illustration of certain empirical design tools that can be utilized to provide initial design points for grating design. Moreover, while the structure described in FIG. 11A and simulated here is a transmission grating, as will be apparent below, grating for EPE/CPE structures can include reflection gratings too.

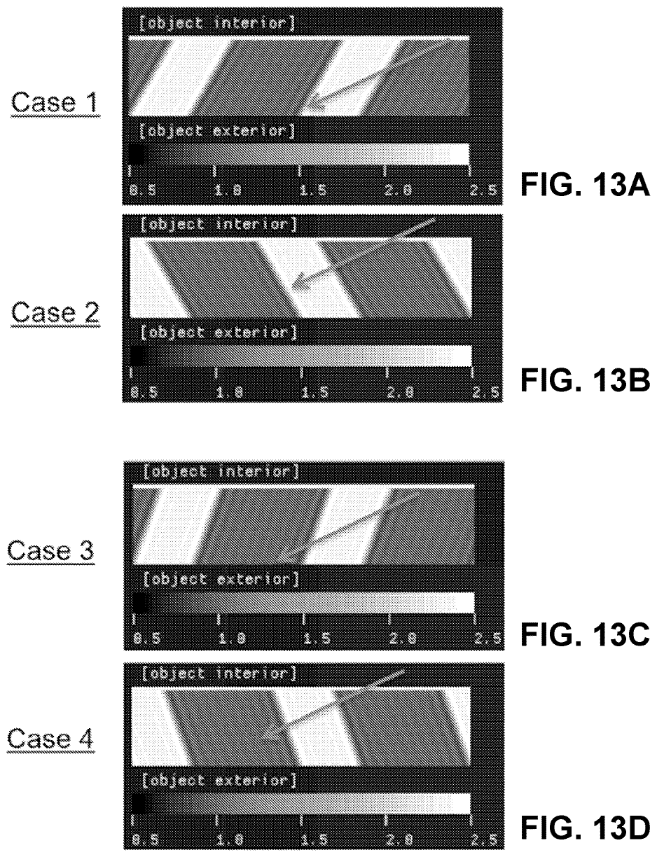

To further investigate the design space for slanted gratings, additional examples were simulated. In particular, four slanted structures were simulated as well as a baseline structure. The slanted structures are graphically depicted in FIGS. 13A-13D, respectively. Table 1 below includes the parameter values for each example and in each case, the thickness of the RLT layer was 10 nm and the simulation wavelength was 525 nm. In the figures, the arrow shows the incident light direction. The grating ridges and RLT layer had a refractive index of 2.0 to 2.5. The troughs had a refractive index of 1.0.

TABLE 1

| | | Thickness | Slant Angle | Duty Cycle |
|---|---|---|---|---|
| FIG. | Structure | (nm) | (°) | (%) |
| N/A | Baseline | 90 | 90 | 35 |
| FIG. 13A | Slanted | 170 | 60 | 35 |
| FIG. 13B | Slanted | 170 | 120 | 35 |
| FIG. 13C | Slanted | 170 | 70 | 35 |
| FIG. 13D | Slanted | 170 | 110 | 35 |

Results of the simulation are shown in Table 2, below. RXD and TXD correspond to the RX-1 and TX-1 diffraction efficiencies. In columns two through five, S and P correspond to the input polarization while AV (cols. six and seven) refers to the average of S/P values. DTOT is sum of the average efficiency values. This parameter is related to the uniformity over FOV. TXRXAV and RXTXAV are the ratios TXAV/RXAV and RXAV/TXAV respectively, which are a measure of grating directionality.

TABLE 2

| FIG./Structure | RXDS | TXDS | RXDP | TXDP | RXAV | TXAV | DTOT | TXRXAV | RXTXAV |
|---|---|---|---|---|---|---|---|---|---|
| Baseline | 4.51 | 4.22 | 2.37 | 2.16 | 3.44 | 3.19 | 6.63 | 0.93 | 1.08 |
| FIG. 13A | 1.2542 | 9.4454 | 0.4011 | 2.9514 | 0.8277 | 6.1984 | 7.0261 | 7.4891 | 0.1335 |
| FIG. 13B | 6.8454 | 3.0738 | 2.5102 | 0.8594 | 4.6778 | 1.9666 | 6.6444 | 0.4204 | 2.3786 |
| FIG. 13C | 2.0686 | 8.8536 | 0.6956 | 2.6511 | 1.3821 | 5.7524 | 7.1345 | 4.162 | 0.2403 |
| FIG. 13D | 5.8281 | 4.4683 | 2.1394 | 1.204 | 3.9837 | 2.8361 | 6.8199 | 0.7119 | 1.4046 |

Columns nine and ten provide a sense of the directionality. The values for the baseline grating are approximately 1 (0.93 and 1.08, specifically) indicating approximately equal amounts of light towards the user and world sides. The slanted grating structures of FIG. 13A and FIG. 13C show more directionality towards the TX side (e.g., user side for EPE 1200) while the slanted grating structures of FIG. 13B and FIG. 13D show more directionality towards the RX side (e.g., world side for EPE 1200). In general, different cases may be chosen for different eyepiece architecture as appropriate, but in either case, slanted grating structures can be designed to provide asymmetric light extraction from the waveguide.

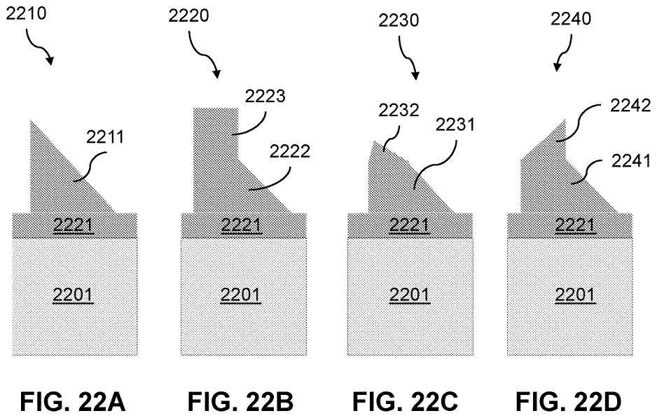

While the foregoing simulation examples were based on gratings with trapezoidal grating ridges, other cross-sectional shapes of grating ridges are also possible. For example, blazed gratings that feature sawtooth ridges or stepped ridges are possible. Example ridge shaped are shown in FIG. 22, discussed below.

For example FIG. 22 illustrates example cross-sectional shapes 2200 of grating ridges. Cross-sectional shape 2210 includes a single sloped geometry, cross-sectional shape 2220 includes a multi-step sloped geometry, e. g., a slope with a step. Cross-sectional shapes 2230 and 2240 feature other multi-step sloped geometries, e. g., two, different slope angles.

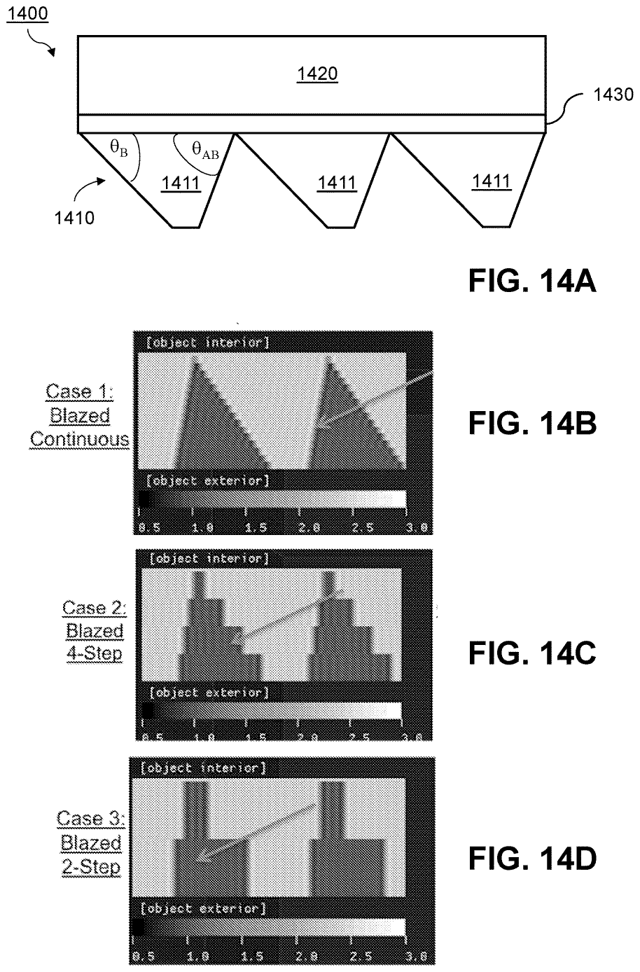

FIG. 14A shows, in cross-section, a portion of an EPE/CPE 1400 includes a sawtooth grating 1410 on a resist RLT layer 1430 supported by a substrate 1420. The sawtooth grating 1410 is composed of ridges 1411, which each are characterized by a shallower blaze angle, θ_{B}, and a steeper anti-blaze angle, θ_{AB}. For grating 1410, grating height, period, and duty cycle are defined as above. Grating width is calculated at the base of each ridge 1411 (i.e., at it's thickest part). Further, the ridges of blazed gratings can have smooth faces or can be stepped. Each of these parameters can be determined/optimized using the methods disclosed herein.

Referring to FIGS. 14B-14D, examples of blazed gratings were simulated as follows. In particular, a continuous blazed grating (FIG. 14B) and a four step blazed grating (FIG. 14C) were simulated. The parameters for these structures are summarized in Table 3 below.

TABLE 3

| | | Thickness | Blaze ang. | Anti-blaze | Duty Cycle |
|---|---|---|---|---|---|
| FIG. | Type | (nm) | (°) | ang. (°) | (%) |
| 14A | Blazed: | 322 | 55 | 80 | 100 |
| | continuous | | | | |
| 14B | Blazed: four- | 322 | 55 | 80 | 100 |
| | step | | | | |
| 14C | Blazed: two- | 322 | 55 | 80 | 100 |
| | step | | | | |

Results of the simulations are shown in Table 4. In each case, the ratio of transmitted light to reflected light is approximately 10:1.

TABLE 4

| FIG. | RXDS | TXDS | RXDP | TXDP | RXAV | TXAV | DTOT | TXRXAV | RXTXAV |
|---|---|---|---|---|---|---|---|---|---|
| 14B | 7.37 | 0.2 | 5.53 | 1.2 | 6.45 | 0.7 | 7.15 | 0.11 | 9.24 |
| 14C | 6.64 | 0.18 | 4.4 | 1.03 | 5.52 | 0.6 | 6.12 | 0.11 | 9.18 |

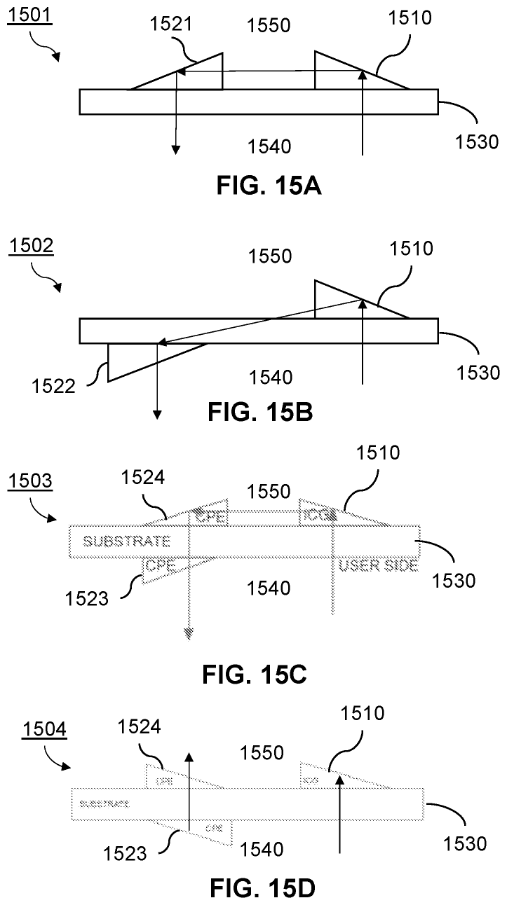

In general, diffractive structures that provide asymmetric light extraction from a waveguide as described above can be deployed in a variety of configurations in an eyepiece, e.g., on a waveguide in combination with an ICG. For example, gratings for EPE and/or CPEs can be provided on one or both surfaces of the waveguide. Examples of single-side deployment are shown in FIGS. 15A and 15B. In eyepiece 1501, shown in FIG. 15A, an ICG 1510 and an EPE 1521 are formed on the same side of a waveguide 1530. EPE 1521 is designed to preferentially extract light from the light guide toward user side 1540 using the design principles described above. In eyepiece 1502, shown in FIG. 15B, ICG 1510 and an EPE 1522 are formed on opposing sides of the same waveguide 1530. Like for eyepiece 1501, EPE 1522 is designed to preferentially extract light from the light guide toward user side 1540.

FIG. 15C shows a two-sided configuration in which a CPE is composed of two gratings 1523 and 1524 formed on opposing sides of waveguide 1530. In this design, both gratings 1523 and 1524 are designed so that an eyepiece 1503 preferentially directs light to the user side 1540. FIG. 15D shows another two-sided configuration in which a CPE is composed of two gratings 1525 and 1526 formed on opposing sides of an eyepiece 1504 to preferentially direct light to the world side 1550.

In general, the structure of a grating for an EPE or CPE can be uniform across the eyepiece or the grating structure can vary. The grating structure can vary abruptly or continuously. Structural characteristics that can vary include, for example, one or more of blaze angle, anti-blaze angle, height, ridge width, period, duty cycle, etc. These characteristics can vary in a direction from the ICG to the side of the EPE/CPE opposite the ICG, or in other directions. In some examples, the structural characteristics can vary in more than one direction.

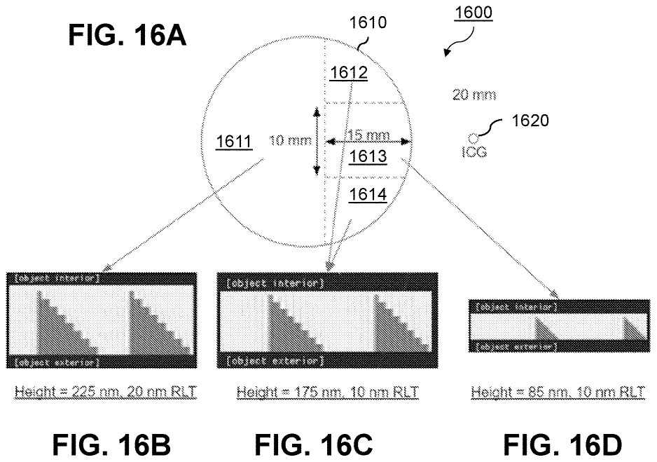

Referring to FIG. 16A-16D, in some examples, an eyepiece 1600 include a CPE 1610 with four zones (1611-1614) each having a grating with a different structure from its neighboring zones. The grating structures are for each zone 1611-1614 are shown in cross-section in FIGS. 16B-16D. Specifically, the zone closest to ICG 1620, zone 1612, includes an RLT layer with a thickness of 10 nm and a grating height of 85 nm, as shown in FIG. 16D.

The zone furthest from ICG 1620, zone 1611. Has an RLT layer with a thickness of 20 nm and a grating height of 225 nm, as shown in FIG. 16B. The other two zones, zones 1612 and 1614, both have an RLT layer with a thickness of 10 nm and a grating height of 175 nm. All the gratings have a blaze angle of 450 and an anti-blaze angle of 90°.

Simulations of such a grating structure with a blazed grating on either side of a substrate having a refractive index of 2.0 with a 400 nm TTV, in which the gratings and RLT layer have an index of 1.65 have demonstrated a 9.7% user side efficiency and a 1.6% world side efficiency.

Generally, light extraction efficiency can vary over the area of a CPE and use of zones of different grating structure and/or a continuously varying grating structure and be used to reduce variations in extraction efficiency across the CPE. For example, in some examples, a CPE has a user side extraction efficiency that varies by a factor of three or less across the entire area (e.g., 2.5 or less, 2 or less, 1.5 or less). In certain examples, a CPE can have a user side extraction efficiency that has a minimum value of 4% or more (e.g., 5% or more, 6% or more, 7% or more) and a maximum efficiency of 15% or less (e.g., 14% or less, 13% or less, 12% or less, 11% or less, 10% or less). In some examples, user side extraction efficiency is a maximum at the center of the CPE.

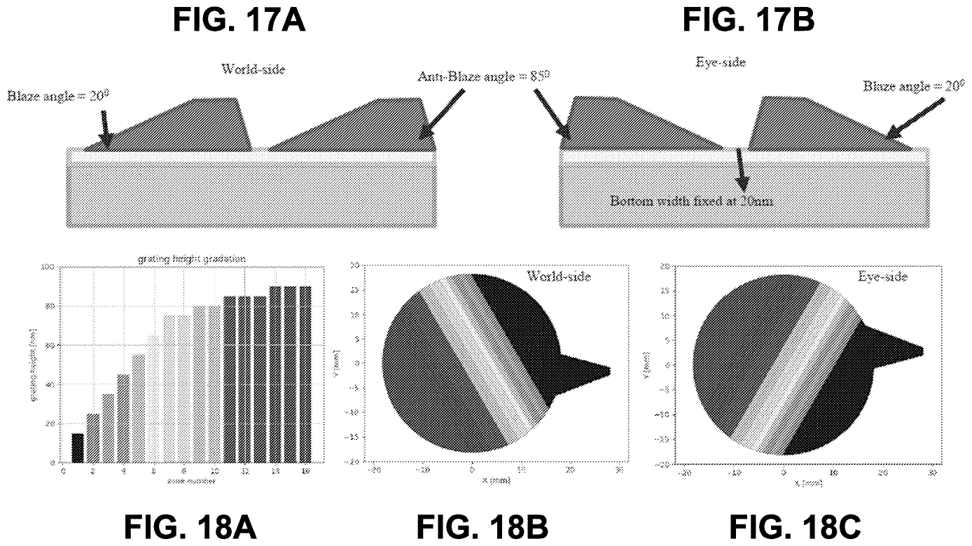

A further example of a blaze sawtooth CPE structure with a gradation pattern is shown in FIGS. 17A-18E. FIGS. 17A-17B show cross-sectional profiles of the blaze sawtooth structure on the world side (FIG. 17A) and user side (FIG. 17B) of the CPE. In this example, both structures have ridges having a blaze angle of 200 and an anti-blaze angle of 85°. Adjacent ridges are separated by a gap of 20 nm.

FIG. 18A shows a plot showing the grating height variation across the gratings. Each grating has 16 zones with the shortest gratings closest to the ICG. The grating height increases monotonically from a minimum of 15 nm to a maximum of 90 nm for the zone furthest from the ICG. FIGS. 18B-18C show the relative orientation of the grating lines for the world side (FIG. 18B) and user side (FIG. 18C), respectively.

While the foregoing example grating structures are one-dimensional gratings, other implementations are possible. For example, in some embodiments, an array of structures can also be arranged in two directions to form a two dimensional (2D) array of diffractive features. The 2D array of diffractive features can include undulations in two directions. In some instances, the undulations can be periodic, while in other instances, the pitch of the undulations can vary in at least one direction. According to various examples described herein, the diffractive features have opposing sidewalls that are asymmetrically angled or tilted. According to various examples described herein, the diffractive features may be tapered.

In some implementations, the diffractive features can have opposing sidewalls that are substantially angled or tilted. In some implementations, the opposing sidewalls may be tilted in the same direction, while in other implementations, the opposing sidewalls may be tilted in opposite directions. In some other implementations, the diffractive features can have one of the opposing sidewalls that is substantially tilted, while having the other of the sidewalls that is substantially vertical or orthogonal to the horizontal axis or is at least tilted less than the other sidewall. In various examples of 2D diffractive features described herein, the 2D diffractive features can be formed in or on the underlying substrate, which can be a waveguide, as described above for various examples of 1D diffractive features. For example, the 2D diffractive features can be etched into the underlying substrate or be formed by patterning a separate layer formed thereon. Thus, the 2D diffractive features can be formed of the same or different material as the material of the substrate, in a similar manner as described above for various 2D diffractive features. Other variations and configurations are possible.

Accordingly, any of the structures or devices described herein such as grating structures may comprise a 1D grating. Similarly, any of the structures or devices described herein such as grating structures may comprise a 2D grating. Such 2D gratings may spread the light. These gratings may also comprise blazed gratings. Such blazed gratings may preferentially direct light in certain directions. In some implementations, the 2D gratings (e.g., having one tilted facet on the diffractive features) preferentially direct light in one direction while in others the 2D grating (e.g., having two tilted facets on the diffractive features differently) preferentially direct light into a plurality of directions Likewise, any of the methods or processes described herein can be used for 1D gratings. Similarly, any of the methods or processes described herein can be used for 2D gratings. These gratings, 1D or 2D, may be included in or on a substrate and/or waveguide and may be included in an eyepiece and possibly integrated into a head-mounted display as disclosed herein. These gratings may be employed as input gratings (e.g., ICGs), output gratings (EPEs), light distribution gratings (OPEs) or combined light distribution gratings/output gratings (e.g., CPEs).

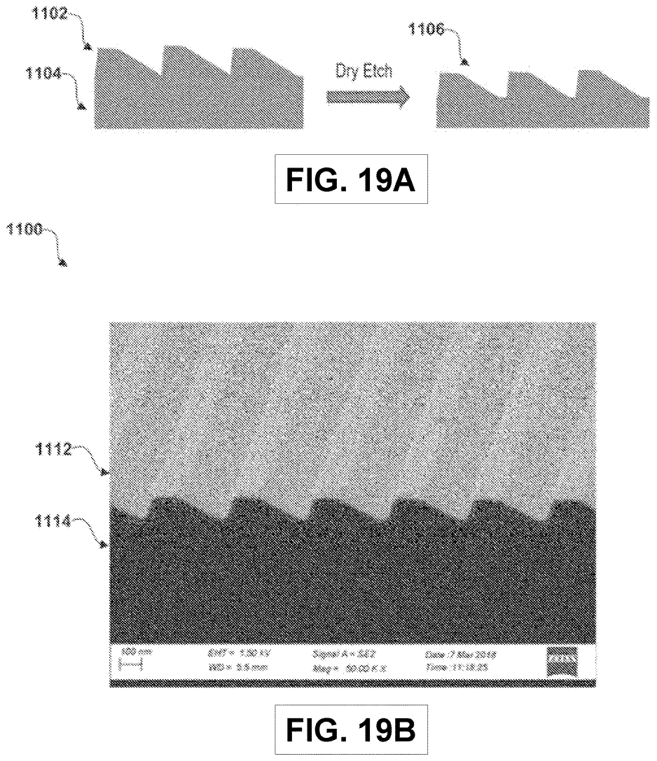

In general, blazed diffraction gratings of either single-step or multi-step geometry are possible and a variety of techniques can be used to form the gratings. In the example shown in FIGS. 19A-19B, gratings can be formed by depositing blazed photoresist and then etching and patterning the photoresist.

Example methods of forming blazed gratings and examples of various blazed grating geometries are described in US20210072437A1, entitled “Display device with diffraction grating having reduced polarization sensitivity,” the entire contents of which are incorporated herein by reference.

FIG. 19A illustrates the formation of a single-step blazed grating 1106 in a substrate 1104, which may be a waveguide 1004 (see, e.g., FIG. 10). A patternable material such as photoresist 1102 is deposited onto a substrate 1104, which be or include a waveguide 1104. The patternable material/photoresist 1102 is patterned to have a shape of the blazed grating. Forming a blazed geometry in the photoresist 1102 may, in some implementations, involve imprinting a pattern such as a single-step “sawtooth” pattern in the photoresist 1102 (e.g., depositing photoresist on the substrate 1104 and then imprinting the blazed geometry). The photoresist 1102 may include a mask such as a hard mask. The patterned photoresist 1102 and the substrate 1104 may then be etched to form a blazed pattern in substrate 1106. Etching the photoresist 1102 and the substrate 1104 may involve a dry plasma or chemical etch and/or a wet chemical etch, for example. In some implementations, the etching illustrated in FIG. 19A may etch away material at a relatively constant rate, such that portions where the patterned photoresist was the thickest result in a relatively smaller amount of removal, e.g., negligible or no removal, of the material from the substrate, while portions where the patterned photoresist was the thinnest (or non-existent) result in a relatively large amount of removal of the material from the substrate or the deepest etches into the substrate.

FIG. 19B is a scanning electron micrograph of a blazed photoresist grating 1112, wherein a blazed grating pattern is formed in a photoresist 1104, for example by imprinting the photoresist with a patterned master. The diffraction grating 1112 shown has a single-step blazed geometry.

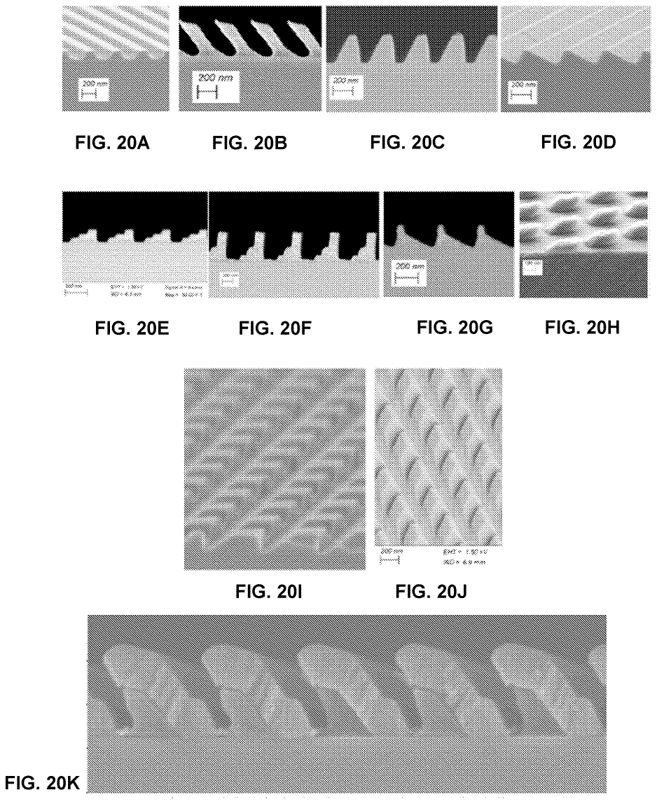

Referring to FIGS. 20A-20K, SEM micrographs of a number of grating structures that can be suitable for EPE/CPE structures described above are shown. FIGS. 20A-20G show examples of one-dimensional gratings. FIGS. 20H-20J show examples of two-dimensional grating structures.

Furthermore, in some examples, gratings can include a one-sided or conformal coating with a different material on the grating ridges. For example, FIG. 20K shows a slanted sharkfin grating imprinted with 1.53 index resist and thin RLT of <20 nm with blazed TiO₂ coating of ~2.2 index deposited over. It is believed this can lead to low index (e.g., index of 1.3 to 1.5) slanted structures have even higher diffraction directionality.

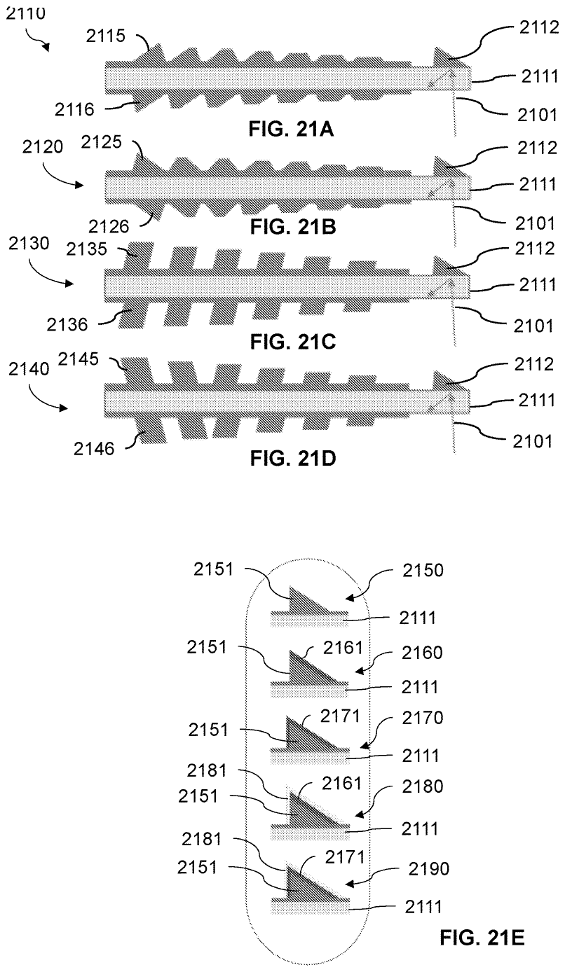

Further examples of eyepieces featuring EPEs with double-sided gratings are shown in FIGS. 21A-21D. Here, each structure is illustrated in cross-section and includes an ICG 212 on a side of a waveguide 2111 opposite the light projector. The direction of light from the projector is show as arrow 2101. Eyepiece 2110, in FIG. 21A, includes a pair of blazed gratings 2115 and 2116 that vary in ridge shape from the side closest to ICG 2112 to the opposite side of the grating. In grating 2115, which is on the same side of waveguide 2111 as ICG 2112, the blazed grating slants towards ICG 2112. In other words, the side of each ridge with the blaze angle is opposite the side closest to the ICG. Grating 2116 is a blaze grating slanting away from the ICG. In both cases, the blaze and anti-blaze angles are the same across each grating and the same in both gratings 2115 and 2116, but the grating height and shape varies. In particular, the height of the grating increases with increasing distance from ICG 2112, and the grating ridges include a flat top surface that decreases in size with increasing distance from ICG 2112.

Eyepiece 2120 includes gratings 2125 and 2126 on opposing sides of waveguide 2111. Here, the grating height varies similarly to the corresponding gratings in eyepiece 2110, but the blaze and anti-blaze angles also vary across the gratings.

Eyepiece 2130 includes a pair of slanted gratings 2135 and 2136 that vary in height, with grating height increasing with increasing distance from ICG 2112. Grating 2135 is slanted towards ICG 2112 and grating 2136 is slanted away. The slant angles are the same for both gratings and are constant across the gratings.

Eyepiece 2140 also includes two slanted gratings 2145 and 2146. In this example, the slant angles change across the gratings. For grating 2145, the ridges are slanted towards ICG 2112 closer to the ICG and slant away further from the ICG. For grating 2146, the ridges are slanted away from ICG 2112 closer to the ICG, then slant towards the ICG. Generally, the slant angles can vary continuously across a grating, or from discrete zone to zone.

In general, the structure of each grating can be determined empirically and can be shaped to manipulate light differently to vary the direction of light emitted from the display for different regions in the user's field of view.

Furthermore, and with reference to FIG. 21E, in general, each grating layer can include a single layered grating or a multilayered structure depending on the implementation. For example, in some examples, a grating layer 2150 includes ridges 2151 formed from a single material (e.g., a resist). In some examples, a grating 2160 can include ridges in which a portion of each ridge includes an additional layer, e.g., a high index layer. For grating 2160, one face of ridge 2151 is coating with a layer 2161 of a high index material, while the opposite face is bare. Grating 2170 includes a high index layer 2171 on both faces of ridge 2151. Grating 2180 includes an additional low index layer 2171 on ridge 2151 along with partial layer 2161 on one face of the ridge. Grating 2190 includes low index layer 2171 on top of layer 2171, which covers both faces of ridge 2151.

Other combinations of high-index and low-index layers are possible on both single- and double-sided diffraction gratings.

As mentioned previously, a variety of grating ridge shapes are contemplated, including those discussed above. Other example ridges shapes are shown in cross-section in FIGS. 22A-22D. Each of these examples feature ridges formed from a single layer of grating material (e.g., a resist) on top of a continuous layer 2221 of the same material, which is supported by a waveguide 2201. FIG. 22A shows a diffractive structure 2210 in which the ridges 2211 have a triangular profile, similar to examples previously discussed. Diffractive structure 2220, shown in FIG. 22B, feature a ridge that has a rectangular portion 2223 on top of a triangular portion 2222, which is truncated. FIGS. 22C and 22D show examples that with ridges that include two triangular portions. Diffractive structure 2230 in FIG. 22C includes two triangular portions 2231 and 2232 which are slanted the same direction. In other words, the blaze angle of both portions is on the same side of the ridge. However, the blaze and anti-blaze angles of portion 2232 are different from those of portion 2231. Portion 2231 is truncated. Diffractive structure 2240 in FIG. 22D includes two triangular portions in which the triangles slant in opposite directions. Here, the lower triangular portion 2241 is truncated. Triangular portion 2241 has the same blaze and anti-blaze angles as portion 2242, but more generally, these can be varied. Diffractive structures0, 2230, and 2240 are considered to feature gratings with ridges with multi-step geometries, which include a sloped step.

Generally, the structure of the grating layers can be determined according to the specific performance demands of the specific application. Accordingly, other embodiments are in the following claims.

1. A head-mounted display system comprising:
a head-mountable frame;
a light projection system configured to output light to provide image content;
a waveguide supported by the frame, the waveguide configured to guide at least a portion of the light from the light projection system coupled into the waveguide; and
a diffractive structure optically coupled to the waveguide, the diffractive structure being configured to couple light guided by the waveguide out of the waveguide towards a user side of the head-mounted display, the diffractive structure comprising a grating layer comprising a plurality of ridges each having a side face that is slanted or stepped with respect to a plane of the waveguide,
wherein the diffractive structure directs at least 25% more light guided by the waveguide towards the user side than a world side.

2. The head-mounted display system of claim 1, wherein the ridges have a profile shape selected from the group consisting of: trapezoidal, parallelogram, triangular, and stepped.

3. The head-mounted display system of claim 1, wherein the side face subtends an angle in a range from 20° to 80° with respect to the plane of the waveguide.

4. The head-mounted display system of claim 1, wherein the ridges have a height in a range from 10 nm to 1,000 nm.

5. The head-mounted display of claim 1, wherein the plurality of ridges have a pitch in a range from 100 nm to 5,000 nm.

6. The head-mounted display system of claim 1, wherein the plurality of ridges have a duty cycle in a range from 20% to 100%.

7. The head-mounted display of claim 1, further comprising a layer of material having a refractive index the same as a material forming the ridges of the diffractive structure, the layer of material being arranged between the waveguide and the diffractive structure.

8. The head-mounted display of claim 7, wherein the layer has a thickness in a range from 5 nm to 50 nm.

9. The head-mounted display of claim 1, wherein the grating layer comprises a grating material having a refractive index of 1.5 or more at an operative wavelength of the output light of the light projection system.

10. The head-mounted display of claim 1, further comprising an input coupling grating (ICG) arranged to couple light into the waveguide, wherein the ICG and the diffractive structure are arranged on a same side of the waveguide.

11. The head-mounted display of claim 1, further comprising an input coupling grating (ICG) arranged to couple light into the waveguide, wherein the ICG and the diffractive structure are arranged on opposite sides of the waveguide.

12. The head-mounted display of claim 1, wherein the diffractive structure is a component of an Exit Pupil Expander (EPE) or a combined pupil expander (CPE) of the head-mounted display.

13. The head-mounted display of claim 12, wherein the diffractive structure is a first diffractive structure and the EPE or CPE further comprises a second diffractive structure on an opposite side of the waveguide from the first diffractive structure.

14. The head-mounted display of claim 1, wherein the diffractive structure comprises zones, wherein a geometry of the grating layer in at least two of the zones is different.

15. The head-mounted display of claim 14, wherein the grating structure of the grating layer changes abruptly from a first zone to a second zone neighboring the first zone.

16. The head-mounted display of claim 14, wherein the grating structure of the grating layer changes continuously across an area of the diffractive structure.

17. (canceled)

18. The head-mounted display of claim 1, wherein at least some of the ridges have a multi-step geometry, wherein the ridges with a multi-step geometry include steps with a sloped geometry.

19. (canceled)

20. The head-mounted display of claim 1, wherein the diffractive structure directs at least 100% more light guided by the waveguide towards the user side than the world side.

21. The head-mounted display of claim 1, wherein the diffractive structure directs at least 4% of light from the waveguide to the user side.

22. The head-mounted display of claim 1, wherein the grating layer is etched into the waveguide.

23. The head-mounted display of claim 1, wherein the grating layer is formed in a layer of material deposited on the waveguide, the layer of material having a refractive index in a range from 1.5 to 2.7.

24. The head-mounted display of claim 1, wherein the diffractive structure comprises a layer of material deposited on the ridges of the grating layer.

25-28. (canceled)
